(19) United States
(12) Patent Application Publication
(10) Pub. No.: US 2022/0080522 A1
(43) Pub. Date: Mar. 17, 2022

(54) HYBRID SOLID-STATE ADDITIVE AND SUBTRACTIVE MANUFACTURING PROCESSES, MATERIALS USED AND PARTS FABRICATED WITH THE HYBRID PROCESSES

(71) Applicant: MELD MANUFACTURING CORPORATION, Christiansburg, VA (US)

(72) Inventors: Chase Cox, Radford, VA (US); Christopher Garguilo, Blacksburg, VA (US); Nanci Hardwick, Blacksburg, VA (US)

(21) Appl. No.: 17/325,831

(22) Filed: May 20, 2021

Related U.S. Application Data
(63) Continuation of application No. PCT/US2019/062604, filed on Nov. 21, 2019.
(60) Provisional application No. 62/770,551, filed on Nov. 21, 2018.

(51) Int. Cl. B23K 20/12; B33Y 10/00; B33Y 40/20

(52) U.S. Cl. CPC B23K 20/1215; B23K 20/1265; F28F 2255/00; B33Y 40/20; B33Y 10/00

(57) ABSTRACT

Solid-state additive and subtractive manufacturing processes, completely or partially performed by a solid-state manufacturing system, are disclosed. Solid-state deposition processes of different materials for printing 3D parts, coating, joining or repair are included as examples. Subtractive processing steps, such as machining, drilling, surface grooving, surface activation and others are discussed as well. In addition, other processes performed by other means are mentioned in making the final parts.

### CROSS-REFERENCE TO RELATED APPLICATIONS

The present application is a continuation application of PCT/2019/062604 filed on Nov. 21, 2019. PCT/2019/062604 application relies on the disclosure of and claims priority to and the benefit of the filing date of U.S. Provisional Application No. 62/770,551 filed Nov. 21, 2018, which is hereby incorporated by reference in its entirety.

### BACKGROUND

### Field of the Invention

The present invention is directed to the fields of solid-state manufacturing, material joining and additive manufacturing. More particularly, embodiments of the invention are directed to a hybrid solid-state manufacturing process involving additive and subtractive steps to produce a finished 3D object or part.

### Description of Related Art

Additive manufacturing or 3D printing, defined as a process of joining materials to make 3D objects usually by layer-by-layer deposition, is capable of producing multi-functional and multi-material parts. However, very often the interfaces between the 3D-printed layers introduce weak spots in the 3D built object. Namely, substantial differences in mechanical properties exist between interfacial and non-interfacial material micro-structures in the 3D object leading to inhomogeneous properties (failure) along specific sites and directions. In such cases, the fabricated parts exhibit inferior properties in comparison to the properties of the bulk material(s).

Subtractive manufacturing is a process by which 3D objects are made by successively cutting material away from a solid block of material. Subtractive manufacturing can be done by cutting the material with a CNC machine. Advanced versions of CNC machines utilize multiple tools and cut around at least three (x, y, and z) axes, and thus minimize the requirement for operators to rotate the workpiece (object).

For numerous applications, there is often a need for consecutive execution of additive and subtractive manufacturing steps, or so-called hybrid additive manufacturing of 3D objects.

Hybrid additive manufacturing is generally considered to be a combination of additive manufacturing (3D printing) and subtractive manufacturing (CNC milling) technologies in a single machine.

Solid-state additive manufacturing technology is a solid-state thermo-mechanical deposition process capable of depositing a material, multiple materials or proprietary compositions on a workpiece, mixing and homogenizing the materials in the processed interfacial zone and generating a good bonding between the deposited material and the workpiece without their melting. Briefly, no-melt solid-state additive manufacturing technology is based on friction between the material deposited via the solid-state additive manufacturing tool which includes an internal passageway, where frictional and other forces as well as the generated heat cause significant material deformation in the vicinity of the rotating tool. The materials adjacent to the tool (the filler material supplied via the tool and the surface material layer of a workpiece) often are in a so-called malleable state, and are mechanically-stirred and mixed together. Due to its no-melt nature, solid-state additive manufacturing technology yields strong interfaces between deposited layers of similar or dissimilar materials or materials that form eutectic mixtures and could not be joined by other technologies known in the art. Furthermore, the solid-state additive manufacturing system offers the possibility of manufacturing 3D objects via hybrid additive manufacturing by performing additive and subtractive steps, while overcoming the challenges associated with other technologies.

### SUMMARY

Embodiments of the invention are directed to hybrid solid-state manufacturing process involving additive and subtractive steps to produce a finished 3D object or part. Various Embodiment of the invention are provided below. However, these should not be construed to be limiting.

Embodiment 1. A hybrid manufacturing process comprising:

depositing filler material(s) by a hybrid manufacturing system by way of one or more additive steps to form a 3D printed part, wherein the one or more additive steps comprise:

feeding one or more filler material(s) through a hollow spindle or tool of the hybrid manufacturing system;

depositing the filler materials(s) onto a substrate; and

generating plastic deformation, such as severe plastic deformation, of the filler material(s) and the substrate by applying normal, shear and/or frictional forces by way of a rotating shoulder of the hollow spindle or tool such that the filler material(s) and/or the substrate are in a malleable and/or visco-elastic state in an interface region, thereby producing the 3D printed part; and

removing material from the 3D printed part by the hybrid manufacturing system by way of one or more subtractive steps such that surface and/or internal features are formed on and/or within the 3D printed part to form a finished part.

Embodiment 2. The process of Embodiment 1, wherein the hybrid manufacturing process does not require additional tools, machines and/or equipment to complete the finished part.

Embodiment 3. The process of Embodiment 1, wherein the hybrid manufacturing process requires additional tools, machines and/or equipment to complete the finished part.

Embodiment 4. The process of Embodiment 1 or any preceding Embodiment, further comprising fabricating the 3D printed part by way of one or more post-fabrication steps, which steps are performed by other tools and/or machines.

Embodiment 5. The process of any preceding Embodiment, wherein the one or more post-fabrication steps comprise calendaring steps.

Embodiment 6. The process of any preceding Embodiment, wherein the one or more post-fabrication steps comprise compressing steps performed by and/or between one or more pairs of cold rollers.

Embodiment 7. The process of any preceding Embodiment, wherein the one or more post-fabrication steps comprise compressing steps performed by and/or between one or more pairs of hot rollers.

Embodiment 8. The process of any preceding Embodiment, wherein the one or more post-fabrication steps comprise cooling the 3D printed part.

Embodiment 9. The process of any preceding Embodiment, wherein the one or more post-fabrication steps comprise quenching the 3D printed part.

Embodiment 10. The process of any preceding Embodiment, wherein the one or more post-fabrication steps comprise heating the 3D printed part.

Embodiment 11. The process of any preceding Embodiment, wherein the one or more post-fabrication steps comprise peening the 3D printed part.

Embodiment 12. The process of any preceding Embodiment, wherein the one or more post-fabrication steps comprise lasering the 3D printed part.

Embodiment 13. The process of any preceding Embodiment, further comprising one or more additional processing steps.

Embodiment 14. The process of any preceding Embodiment, wherein the one or more additional processing steps comprise peening.

Embodiment 15. The process of any preceding Embodiment, wherein the one or more additional processing steps comprise lasering.

Embodiment 16. The process of any preceding Embodiment, wherein the one or more additional processing steps comprise cooling.

Embodiment 17. The process of any preceding Embodiment, wherein the one or more additional processing steps comprise quenching.

Embodiment 18. The process of any preceding Embodiment, wherein the hybrid manufacturing process is capable of producing internal features in the finished part.

Embodiment 19. The process of any preceding Embodiment, wherein the hybrid manufacturing process is capable of producing surface features in the finished part.

Embodiment 20. The process of any preceding Embodiment, wherein the hybrid manufacturing process is capable of producing heating or cooling channels in the finished part.

Embodiment 21. The process of any preceding Embodiment, wherein the hybrid manufacturing process is capable of depositing two or more filler materials during the additive manufacturing steps.

Embodiment 22. The process of any preceding Embodiment, wherein the hybrid manufacturing process is capable of removing material from the 3D printed part by way of the one or more subtractive steps.

Embodiment 23. The process of any preceding Embodiment, wherein the one or more subtractive steps comprise drilling on and/or within the 3D printed part.

Embodiment 24. The process of any preceding Embodiment, wherein the one or more subtractive steps comprise cutting on and/or within the 3D printed part.

Embodiment 25. The process of any preceding Embodiment, wherein the one or more subtractive steps comprise surface finishing of the 3D printed part.

Embodiment 26. The process of any preceding Embodiment, wherein the one or more subtractive steps comprise machining of the 3D printed part.

Embodiment 27. The process of any preceding Embodiment, wherein the hybrid manufacturing system comprises at least two tools, each capable of performing different additive or subtractive manufacturing steps.

Embodiment 28. The process of any preceding Embodiment, wherein the hybrid manufacturing system consists of only one tool capable of performing both additive and subtractive manufacturing steps.

Embodiment 29. The process of any preceding Embodiment, further comprising incorporating one or more pre-fabricated components in the 3D printed part.

Embodiment 30. The process of any preceding Embodiment, wherein the one or more pre-fabricated components comprise one or more pipes.

Embodiment 31. An additive manufacturing process comprising:

joining a first material and a second material;

wherein the materials are capable of forming a eutectic mixture; and

wherein the first material and second material are joined by way of one or more additional materials and in a manner without forming the eutectic mixture; and

optionally comprising feeding one or more filler material(s) through a solid-state additive manufacturing tool, and rotating and translating the solid-state additive manufacturing tool over at least one surface of the first material and/or second material to join the first material and second material with the filler material(s) without forming the eutectic mixture.

Embodiment 32. The process of any preceding Embodiment, wherein the first and second materials are joined by extrusion.

Embodiment 33. The process of any preceding Embodiment, wherein the first and second materials are joined by at least one plate.

Embodiment 34. The process of any preceding Embodiment, wherein the first and second materials are joined by rotating and translating the solid-state additive manufacturing tool over one surface of the at least one plate.

Embodiment 35. The process of any preceding Embodiment, wherein the first and second materials are joined by rotating and translating the solid-state additive manufacturing tool over more than one surface of the at least one plate.

Embodiment 36. The process of any preceding Embodiment, wherein the first and second materials are joined in a T-configuration.

Embodiment 37. The process of any preceding Embodiment, wherein the first and second materials are joined in a corner joint configuration.

Embodiment 38. The process of any preceding Embodiment, wherein the additive manufacturing process is capable of repairing parts or substrates with defective spots or cracks.

Embodiment 39. The process of any preceding Embodiment, wherein the additive manufacturing process is capable of printing 3D parts by extruding one deposited layer material into the layer underneath that is previously deposited.

Embodiment 40. The process of any preceding Embodiment, wherein the process is capable of repairing parts or substrates with defective spots or cracks.

Embodiment 41. The process of any preceding Embodiment, wherein the one or more additive and/or subtractive steps are performed in a medium other than air.

Embodiment 42. The process of any preceding Embodiment, wherein the medium is water.

Embodiment 43. The process of any preceding Embodiment, wherein the one or more additive steps are capable of refining the microstructure of the finished part.

Embodiment 44. The process of any preceding Embodiment, wherein the microstructure is an ultrafine grained microstructure.

Embodiment 45. The process of any preceding Embodiment, wherein the one or more additive steps are capable of coating the finished part.

Embodiment 46. The process of any preceding Embodiment, further comprising supporting the 3D printed part by way of one or more modular platforms.

Embodiment 47. The process of any preceding Embodiment, wherein the one or more additive steps incorporate and join different classes of materials together.

Embodiment 48. The process of any preceding Embodiment, wherein the finished part is a sandwiched structure.

Embodiment 49. The process of any preceding Embodiment, wherein the hybrid manufacturing system comprises one or more tools configured to perform subtractive processes.

Embodiment 50. The process of any preceding Embodiment, wherein the one or more tools are capable of drilling the 3D printed part.

Embodiment 51. The process of any preceding Embodiment, wherein the one or more tools are capable of surface grooving the 3D printed part.

Embodiment 52. The process of any preceding Embodiment, wherein the hollow spindle or tool comprises an internal passageway and a feature that opens and closes the internal passageway on demand for adding the filler material(s).

Embodiment 53. The process of any preceding Embodiment, wherein the hollow spindle or tool comprises a shoulder with a finish capable of resisting wear.

Embodiment 54. The process of any preceding Embodiment, wherein the hollow spindle or tool comprises a wear-resistant material.

Embodiment 55. The process of any preceding Embodiment, wherein the one or more additive steps are performed before the one or more subtractive steps or vice versa.

Embodiment 56. The process of any preceding Embodiment, wherein the one or more additive steps and the one or more subtractive steps are performed such that the additive and subtractive steps alternate.

Embodiment 57. The process of any preceding Embodiment, wherein at least one additive step and at least one subtractive step are performed such that the additive and subtractive steps alternate.

Embodiment 58. A hybrid manufacturing process comprising:

depositing filler material(s) by a hybrid manufacturing system by way of one or more additive steps to form a first layer, wherein the one or more additive steps comprise:

feeding one or more filler material(s) through a hollow spindle or tool of the hybrid manufacturing system;

depositing the filler materials(s) onto a substrate; and

generating plastic deformation, such as severe plastic deformation, of the filler material(s) and the substrate by applying normal, shear and/or frictional forces by way of a rotating shoulder of the hollow spindle or tool such that the filler material(s) and/or the substrate are in a malleable and/or visco-elastic state in an interface region, thereby producing the first layer; and

drilling, grinding, or milling a feature in the first layer; and

depositing filler material by a hybrid manufacturing system by way of the one or more additive steps to form a second layer on top of the first layer.

Embodiment 59. The process of any preceding Embodiment, wherein the feature is a first channel.

Embodiment 60. The process of any preceding Embodiment, further comprising drilling, grinding, or milling a second channel in the second layer, wherein the second channel is in communication with the first channel.

Embodiment 61. The process of any preceding Embodiment, further comprising placing a pre-fabricated part in the first channel such that the second layer is formed over the pre-fabricated part.

Embodiment 62. The process of any preceding Embodiment, wherein the pre-fabricated part is a pipe.

Embodiment 63. A hybrid manufacturing process comprising:

depositing filler material(s) by a hybrid manufacturing system by way of one or more additive steps to form a first layer, wherein the one or more additive steps comprise:

feeding one or more filler material(s) through a hollow spindle or tool of the hybrid manufacturing system;

depositing the filler materials(s) onto a substrate; and

generating plastic deformation, such as severe plastic deformation, of the filler material(s) and the substrate by applying normal, shear and/or frictional forces by way of a rotating shoulder of the hollow spindle or tool such that the filler material(s) and/or the substrate are in a malleable and/or visco-elastic state in an interface region, thereby producing the first layer; and

applying mechanical force, an energy source or a cooling source to the first layer in a manner which alters the microstructure of the first layer.

Embodiment 64. The process of any preceding Embodiment, wherein the energy source is laser, plasma, or ultrasound.

Embodiment 65. The process of any preceding Embodiment, wherein the cooling source is ice, dry ice, air, a gas, or a liquid.

Embodiment 66. The process of any preceding Embodiment, wherein the mechanical force is stress, compression or peening.

Embodiment 67. The process of any preceding Embodiment, further comprising depositing filler material(s) by the hybrid manufacturing system by way of the one or more additive steps to form a second layer on top of the first layer, wherein the microstructure of the second layer is different from the first layer.

Embodiment 68. A hybrid manufacturing system, comprising:

a first tool having a body and a throat capable of receiving one or more filler material(s);

a push-down actuator capable of providing a downward force on the filler material;

wherein the first tool comprises a shoulder capable of generating plastic deformation, such as severe plastic deformation, of the filler material(s) when dispensed through the throat by applying normal, shear and/or frictional forces on the filler material(s) and/or a substrate disposed beneath the filler material;

wherein the system further comprises one or more features capable of drilling, grinding, milling, and/or cutting the filler material and/or the substrate.

Embodiment 69. The hybrid manufacturing system of any preceding Embodiment, wherein the first tool further comprises a hollow pin, wherein the one or more features are disposed on the hollow pin.

Embodiment 70. The hybrid manufacturing system of any preceding Embodiment, wherein the one or more features are disposed on the shoulder of the tool.

Embodiment 71. The hybrid manufacturing system of any preceding Embodiment, wherein the one or more features are not disposed on the first tool but are disposed on a second tool.

Embodiment 72. The hybrid manufacturing system of any preceding Embodiment, wherein the second tool does not have an internal passageway.

Embodiment 73. The hybrid manufacturing system of any preceding Embodiment, wherein the one or more features are capable of being retracted into the tool.

Embodiment 74. The hybrid manufacturing system of any preceding Embodiment, further comprising a door capable of blocking or opening the internal passageway.

Embodiment 75. A manufacturing process comprising:

placing a plurality of substrates orthogonally adjacent to each other;

depositing filler material(s) by way of one or more additive steps over a plurality of surfaces of the substrates, wherein the one or more additive steps comprise:

feeding one or more filler material(s) through one or more hollow spindle or tool;

depositing the filler materials(s) onto the plurality of surfaces of the substrates; and

generating plastic deformation, such as severe plastic deformation, of the filler material(s) and the substrates by applying normal, shear and/or frictional forces by way of a rotating shoulder of the one or more hollow spindle or tool such that the filler material(s) and/or the substrates are in a malleable and/or visco-elastic state in an interface region, thereby introducing a bond at an interface of the substrates.

Embodiment 76. The manufacturing process of any preceding Embodiment, wherein the plurality of surfaces are orthogonal to each other.

Embodiment 77. The manufacturing process of any preceding Embodiment, wherein a separate hollow spindle or tool deposits filler material over each orthogonal surface.

Embodiment 78. A manufacturing process comprising:

placing a plurality of substrates orthogonally adjacent to each other;

placing a plurality of plates in communication with the plurality of substrates;

depositing filler material(s) by a hybrid manufacturing system by way of one or more additive steps over a plurality of surfaces of the plates, wherein the one or more additive steps comprise:

feeding one or more filler material(s) through one or more hollow spindle or tool;

depositing the filler materials(s) onto the plurality of surfaces of the plates; and

generating plastic deformation, such as severe plastic deformation, of the filler material(s) and the plates by applying normal, shear and/or frictional forces by way of a rotating shoulder of the hollow spindle or tool such that the filler material(s) and/or the plates are in a malleable and/or visco-elastic state in an interface region, thereby introducing a bond at an interface of the substrates.

Embodiment 79. The manufacturing process of any preceding Embodiment, wherein the plurality of surfaces of the plates are orthogonal to each other.

Embodiment 80. The manufacturing process of any preceding Embodiment, wherein a separate hollow spindle or tool deposits filler material over each orthogonal surface of the plates.

These and other embodiments and their features and advantages will be apparent in the foregoing Detailed Description.

### BRIEF DESCRIPTION OF THE SEVERAL VIEWS OF THE DRAWINGS

The accompanying drawings illustrate certain aspects of embodiments of the present invention, and should not be used to limit the invention. Together with the written description the drawings serve to explain certain principles of the invention.

FIG. 1A is a schematic illustration of a solid-state additive manufacturing process of bonding plates according to an embodiment.

FIG. 1B is a schematic illustration of a product of the solid-state additive manufacturing process of FIG. 1A according to an embodiment.

FIG. 2A is a schematic illustration of a solid-state additive manufacturing process of bonding plates where at least one of the plates has grooves, holes or other surface indentations according to an embodiment.

FIGS. 2B-2D are schematic illustrations of various embodiments of products of a solid-state additive manufacturing process where the plates have different grooves, holes, or other surface indentations.

FIG. 3A is a schematic illustration of a product of a solid-state additive manufacturing process where the product is made by joining plates by multiple solid-state additive manufacturing actions pointed in different directions, according to embodiments.

FIG. 3B is a schematic illustration of a product of a solid-state additive manufacturing process where the product is made by depositing different materials by multiple solid-state additive manufacturing actions pointed in different directions, according to embodiments.

FIGS. 4A-4C are schematic illustrations of a product of a solid-state additive manufacturing process formed by a T-joint, where FIG. 4B and FIG. 4C show the product of FIG. 4A reinforced with one or more plates in the area of the joint, according to embodiments.

FIG. 5A is a schematic illustration which shows two materials to be joined together in a corner joint according to an embodiment.

FIG. 5B is a schematic illustration which shows a product where the two materials of FIG. 5A are joined by extrusion of material into the joint according to an embodiment.

FIG. 5C is a schematic illustration which shows a product where the two materials of FIG. 5A are joined by solid-state additive manufacturing tool action applied along different directions, e.g. along the surface of the plates, according to an embodiment.

FIG. 5D is a schematic illustration which shows a product where the two materials of FIG. 5A are joined by depositing materials in the vicinity of the joint or by plates placed around the joint, according to an embodiment.

FIG. 5E is a schematic illustration which shows a product where the two materials of FIG. 5A are joined by other materials or plates applied to the joint, according to an embodiment.

FIGS. 6A-6F are schematic illustrations which show a tubular structure (FIG. 6A-C) or a semi-tubular structure (FIGS. 6D-6F) having cracks or defects which are according to an embodiment.

FIGS. 7A-7E are schematic illustrations which show the formation of channels in one or more deposited layer according to embodiments.

FIGS. 8A and 8B are schematic illustrations which show deposition of layers (FIG. 8A) and introduction of channel features in the deposited layers (FIG. 8B) according to an embodiment.

FIGS. 9A-9D are schematic illustrations which show parts built from additive and subtractive steps and incorporation of another component into the solid-state additively-manufactured part according to an embodiment.

FIGS. 9E-9H are photographs showing parts built from additive and subtractive steps and incorporation of another component into the solid-state manufacturing system into the solid-state additively-manufactured part according to an embodiment.

FIG. 10 is a schematic illustration showing a stack of deposited layers passing through one or more sets of hot or cold rollers or through a calendaring equipment with the printed stack compressed into a thinner stack of layers according to an embodiment.

FIG. 11 is a schematic illustration showing deposition of a first layer made of a soft material and then a feature made of a harder material by a solid-state additive manufacturing process according to an embodiment.

FIGS. 12A-12D are schematic illustrations of deposited layers undergo a peening step according to embodiments.

FIGS. 13A and 13B are schematic illustration showing a cold air or a gas being applied to achieve rapid cooling during the deposition of a layer with a solid-state additive manufacturing process according to embodiments.

FIG. 13C is a schematic illustration showing a cold liquid or a cold solid material being applied to achieve rapid cooling during the deposition of a layer with a solid-state additive manufacturing process according to an embodiment.

FIG. 13D is a schematic illustration showing deposition via the tool during the solid-state additive manufacturing process occurs in a circulating cold medium according to an embodiment.

FIGS. 14A and 14B are schematic illustrations showing the solid-state additive manufacturing tool used to deposit the layer and used again to move along the surface of the deposited layer to generate refined microstructures according to embodiments.

FIG. 14C is a schematic illustration showing the solid-state additive manufacturing tool geometry and/or the tool shoulder features vary between the original deposition step and the repeated steps according to an embodiment.

FIG. 14D is a schematic diagram showing steps of switching between solid-state additive manufacturing tools according to an embodiment.

FIG. 15 is a schematic diagram showing application of one or more rollers during solid-state additive manufacturing according to an embodiment.

FIG. 16A is a schematic illustration showing a part with a corroded surface.

FIGS. 16B and 16C are schematic illustrations showing repair of the part of FIG. 16A by solid-state additive manufacturing (FIG. 16B) and removal of extraneous material (FIG. 16C) according to an embodiment.

FIGS. 16D and 16E are photographs showing a blade with an internal hole before (FIG. 16D) and after (FIG. 16E) repair by a solid-state additive manufacturing process according to an embodiment.

FIG. 17A is a photograph showing a plate with stiffening ribs that have been extruded with a solid-state additive manufacturing process according to an embodiment.

FIG. 17B is a schematic illustration showing a plate with slots (dies) used as a substrate for the solid-state additive printing according to an embodiment.

FIGS. 17C-17E are schematic illustrations showing material on the back of the substrate and material being pushed through the slot (die) on the back side of the plate forming ribs and/or locking structures (FIGS. 17C and 17D) or a coating (FIG. 17E) according to embodiments.

FIGS. 18A and 18B are schematic illustrations showing a modular platform used in a solid-state additive manufacturing process for supporting large (FIG. 18A) or elongated (FIG. 18B) structures according to embodiments.

FIGS. 19A-19C are schematic illustrations showing hexagonal parts made of ceramics or high-performance plastics embedded during the solid-state additive manufacturing process according to embodiments.

FIG. 19D is a photograph showing ceramic hexagonal parts embedded in aluminum layers deposited by a solid-state additive manufacturing process according to an embodiment.

FIG. 20 is a schematic illustration showing a composite or prepreg layer added during the hybrid additive and subtractive solid-state manufacturing steps according to an embodiment.

FIGS. 21A-21K are schematic illustrations showing hybrid solid-state deposition/grooving tools having a variety of shapes, extensions and/or surface features according to embodiments.

### DETAILED DESCRIPTION

Reference will now be made in detail to various exemplary embodiments of the invention. It is to be understood that the following discussion of exemplary embodiments is not intended as a limitation on the invention. Rather, the following discussion is provided to give the reader a more detailed understanding of certain aspects and features of the invention.

The present invention is related to solid-state additive manufacturing methods to produce 3D objects via additive and subtractive manufacturing steps. Manufacturing methods of 3D objects using the solid-state additive manufacturing system and other manufacturing systems or post-fabrication methods, are disclosed as well. Methods of joining materials that are prone to form eutectic mixtures by avoiding the formation of eutectics are also disclosed.

It should be noted that in the examples and description provided in this application, various modifications can be made and are also intended to be within the scope of the invention. For example, the described manufacturing methods can be practiced using one or more of the method steps described, and in any order. Further, method steps of one method may be interchanged and/or combined with the steps of other methods described and/or with method steps known to those of ordinary skill in the art. Likewise, the features and configurations for particular tooling described in this application may be omitted, interchanged, and/or combined with other features described or known to those of ordinary skill in the art. Even further, tooling to obtain certain results or to perform specific steps of methods described in this application is also included in the scope of the invention.

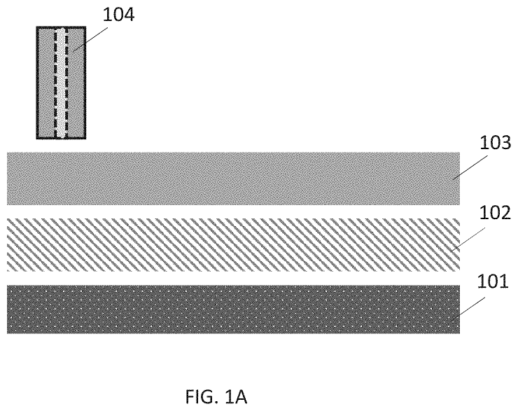

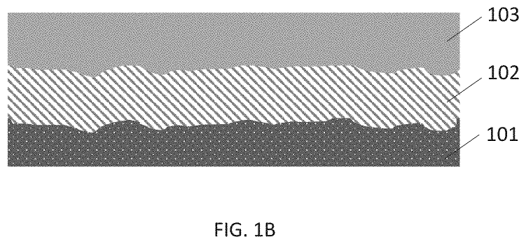

In some embodiments, the solid-state additive manufacturing system is used to make well-bonded parts or substrates made of two materials 101 and 102, where the materials 101 and 102 are prone to form a eutectic mixture when subjected under high temperature and/or pressure (FIG. 1A). The solid-state additive manufacturing joining of 101 and 102 materials occurs without forming a eutectic mixture at the interface between the materials 101 and 102. The joining of the materials is done by applying a third material 103 on top of the plate 102, which needs to be joined to plate 101 underneath. The solid-state additive manufacturing tool action starts by depositing material 103 and then the action continues along the surface of the deposited layers of material 103 (FIG. 1A). The indirect action of the solid-state additive manufacturing tool 104 imposes heating and pressure on the underlying plates 102 and 101 and their interface, but to a much lower temperature and pressure than those imposed along the surface of layer 103. In specific embodiments, the solid-state additive manufacturing tool 104 is actually forcing extrusion of the material 102 into material 101, and therefore, the final outlook of the bonded 101-102 materials will include an interface layer of mixed materials 101 and 102 (FIG. 1B). In other embodiments, a plate 103 is applied on top of plate 102 that needs to be bonded to plate 101.

Examples of material systems, which form eutectic mixtures are as follows, but not limited to aluminum/steel systems (e.g. Al5083 or Al1100 and steel 304), aluminum/magnesium systems, and other metal or other material combinations.

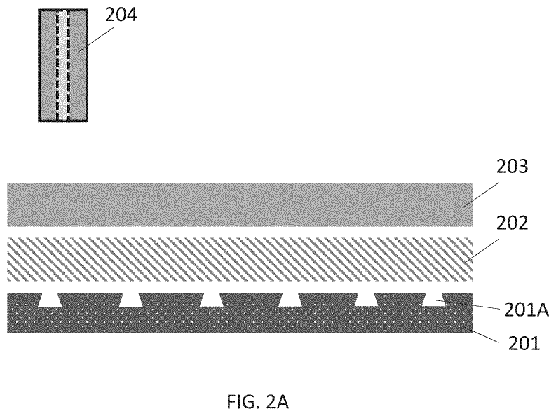

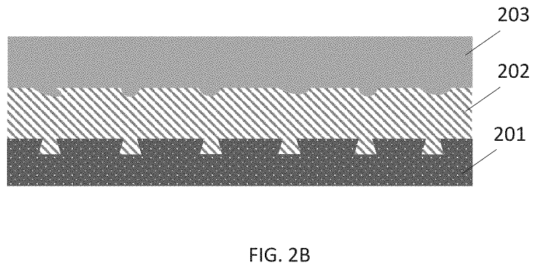

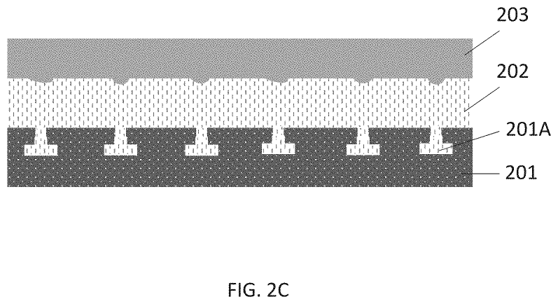

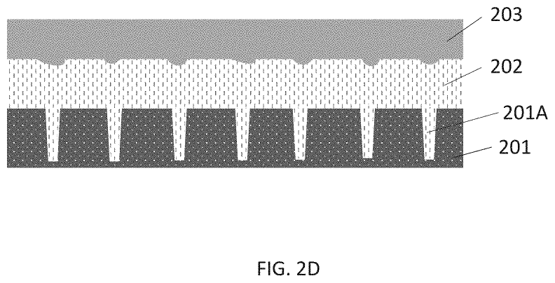

In some embodiments, as shown in FIGS. 2A-2C, the surface of the bottom plate 201 includes grooves, holes or other surface indentations 201A. By indirect solid-state additive manufacturing tool 204 action on top of material 203 (or plate 203), the material 202 (or the plate 202) is extruded (“forced”) into the grooves or holes in the plate 201, and the two plates 201 and 202 are joined without forming a eutectic mixture and without melting occurring at their interface (FIGS. 2A and 2B). The indentations 201A on the surface of plate 201 can be of any shape and size including dove-tail shapes and other inter-locking shapes that provide good joining between two different materials needed to be joined (FIG. 2C).

In certain embodiments, the extrusion of material 202 into material 201 via solid-state additive application of top material 203 is used to generate stiffening structures of a stiffer material 202 into material 201 without interface melting and without forming eutectics (FIG. 2D). In yet another embodiment, the extruded material 202 into material 201 acts as reinforcing structures 201A. In yet other embodiments, the joining of plate 202 to plate 201 occurs using plate 203 and applying the solid-state additive manufacturing tool along the surface of the plate 203.

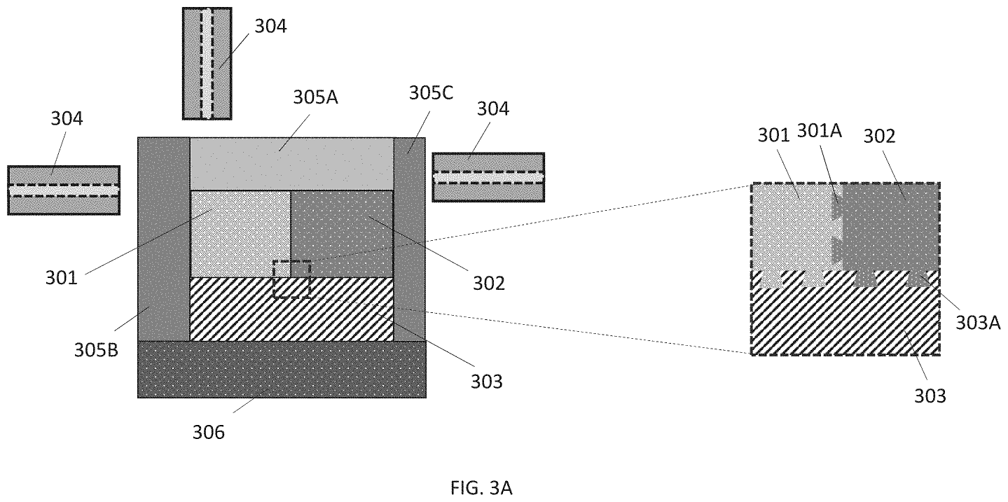

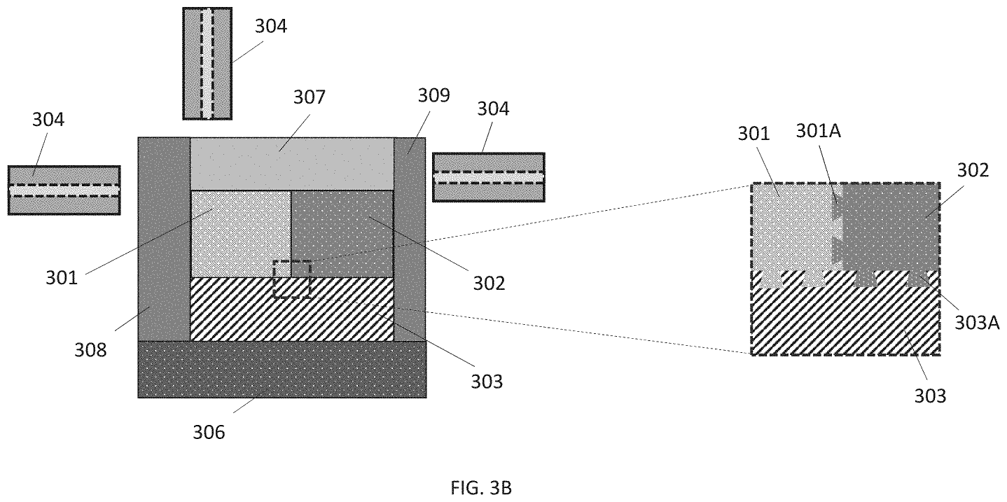

In some embodiments, the object (part) is made by multiple solid-state additive manufacturing tool 304 actions on more than one surface of the object, e.g. the object is made with solid-state additive manufacturing actions pointed in different directions (FIG. 3A). For instance, the part is made of materials 301, 302 and 303, which form eutectic mixtures. To avoid the formation of eutectic mixtures, plates 305A, 305B and 305C are utilized to provide good bonding on the interfaces 301-302, 301-303 and 302-303. The solid-state additive manufacturing tool 304 imposes high intensity friction and other forces along the surface of plate 305A and enables extrusion of the materials 301 and 302 into material 303, which can be placed on a platform 306. Then, the object is rotated 90° and the solid-state additive manufacturing tool 304 action is imposed along the surface of plate 305B and enables bonding of materials 301 and 302. For a stronger lateral bond on the interface 301-302, the object is rotated in such a way for the solid-state additive manufacturing tool 304 to impose an action along the surface of plate 305C, as well. In some embodiments, to achieve a better joining of the materials 301, 302 and 303, grooves or other inter-locking structures on the surface of some of materials, such as 301A and 303A (FIGS. 3A and 3B) are formed prior to the joining process.

In certain embodiments, as presented in FIG. 3B, instead of plates 305A, 305B and 305C as used in the previous embodiment (FIG. 3A), the solid-state additive manufacturing tool 304 action includes of deposition of materials 307, 308 and 309 directly onto the surfaces of 301, 302 and 303 blocks, where the materials 307, 308 and 309 do not form eutectic mixtures with any of the materials 301, 302 and 303, but are used to bond well the interfaces 301-302, 301-303 and 302-303, as presented in FIG. 3B. Materials 307, 308 and 309 can be the same or different materials.

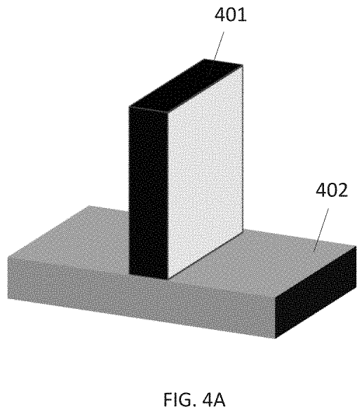

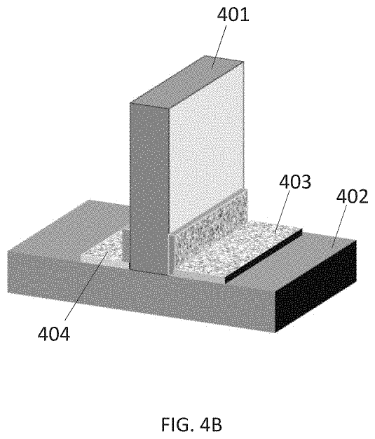

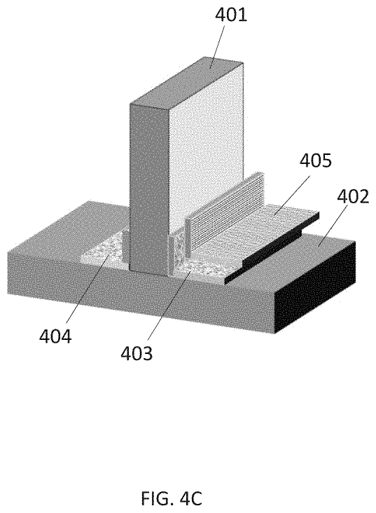

In a specific embodiment, parts 401 and 402 need to be joined without causing melting at the interface (FIG. 4A). Materials 403 and 404 are deposited in the vicinity of the 401-402 joint with the solid-state additive manufacturing system (FIG. 4B) and the solid-state additive manufacturing tool continues to apply frictional and other forces on top of the deposited materials 403 and 404 to further strengthen the 401-402 joint without causing melting at the joint. Materials 403 and 404 can be the same or different materials. In other embodiments, plates 403 and 404 are placed in the vicinity of the 401-402 joint and the solid-state additive manufacturing tool acts along the surface of these plates. In yet another embodiment, additional plates, e.g. 405 and others, are added to ensure good bonding and no-melting in the joint area between 401 and 402 (FIG. 4C).

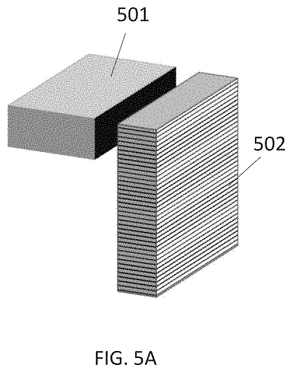

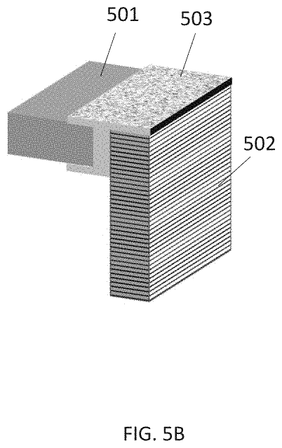

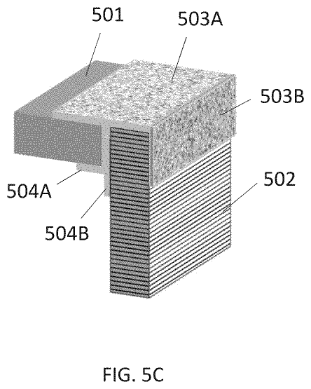

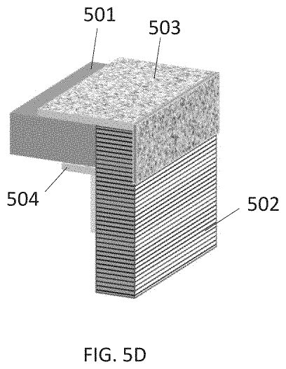

In some embodiments, a third plate is used for corner joining of dissimilar materials 501 and 502 or parts 501 and 502 made of dissimilar materials (FIG. 5A). In specific embodiments, two dissimilar parts 501 and 502 are joined together by extrusion of material 503 into the joint, which is pushed via solid-state additive manufacturing tool action along the surface of the material 503 or the plate 503 (FIG. 5B). In another embodiment, the solid-state additive manufacturing tool action is applied along different directions, e.g. along the surface of the plates 503A, 503B, 504A and 504B (FIG. 5C). In other embodiments, the parts 501 and 502 are joined without extrusion of the material inside the joint, but by depositing 503 and 504 materials in the vicinity of (around) the 501-502 joint (FIG. 5D). In another embodiment, plates 503 and 504 are placed around the joint 501-502 and the solid-state additive manufacturing tool action is applied along the surface of these plates. In yet another embodiment, in cases where materials 501, 502, 503 and 504 form eutectic mixtures and melting should be avoided at the interfaces, other materials or plates are applied, e.g. materials/plates 505 and 506 and the solid-state additive manufacturing tool action occurs on their surface (FIG. 5E).

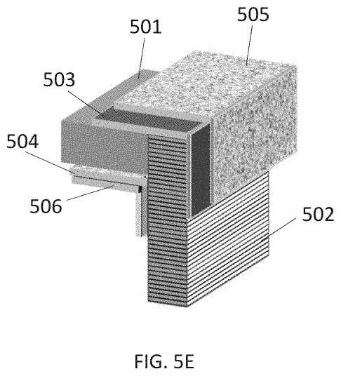

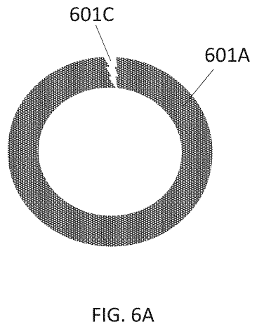

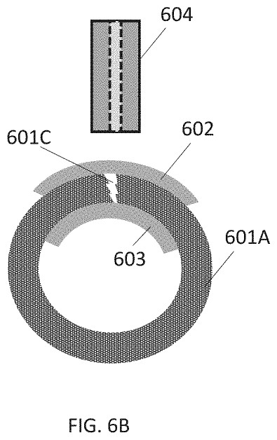

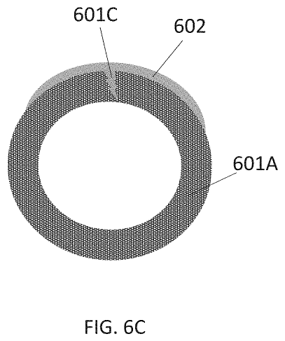

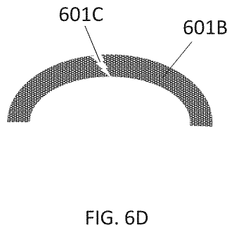

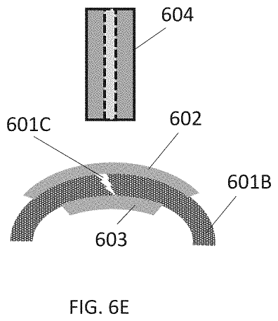

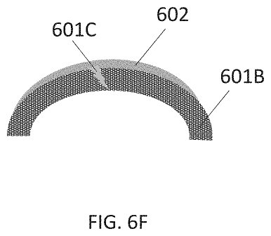

In some embodiments, the solid-state additive manufacturing system is used for repair of difficult to reach spots or parts made of materials that could form eutectic mixtures when repaired under high temperature and/or pressure. As an example only, a tubular structure 601A (FIG. 6A) or semi-tubular structure 601B (FIG. 6D) or any other curved structure with a defect (crack) 601C can be repaired by using one or two of the curved plates 602 and 603 placed around (on both sides of) the defective spot (FIGS. 6B and 6E). By the action of the solid-state additive manufacturing tool along the surface of one of the plates (e.g. along the curved plate 602), the material 602 is extruded (pushed into) the defective spot (crack) 601C. After the repair process, the underlying plate 603 can be removed, while the excess of the top material 602 can be removed by machining, if needed (FIGS. 6C and 6F).

In certain embodiments, the solid-state manufacturing system serves as a hybrid multi-tasking system, which performs additive manufacturing steps, as well as subtractive manufacturing and other processing steps.

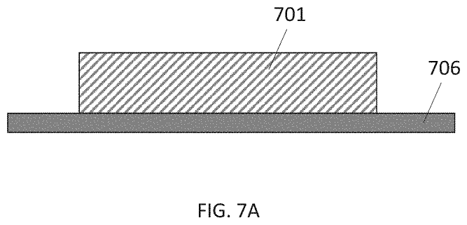

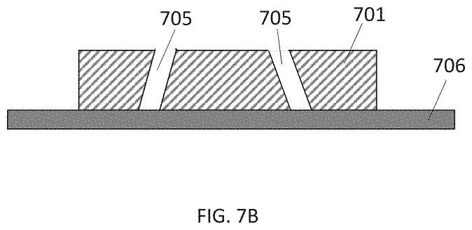

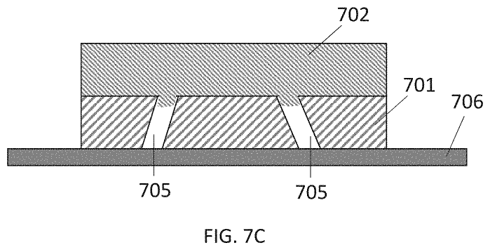

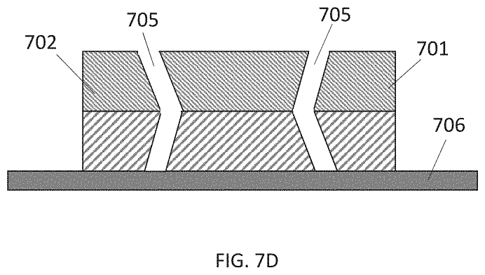

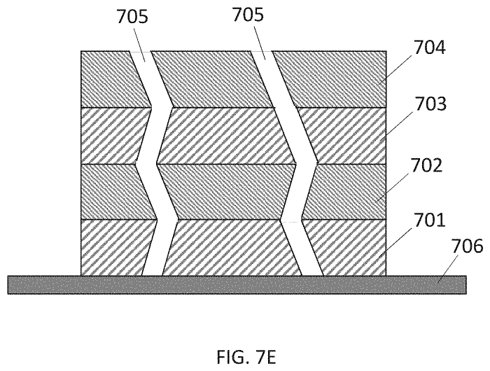

In certain embodiments, the solid-state additive manufacturing deposited parts (objects) include internal channels, e.g. cooling or heating channels 705 (FIGS. 7B-7E). The fabrication of such parts using the hybrid solid-state additive manufacturing system includes, but is not limited to the following steps: (i) solid-state additive deposition of the first layer 701 on a platform 706 (FIG. 7A), (ii) drilling/milling a feature (e.g. channels 705) in the deposited layer 701 (FIG. 7B), (iii) deposition of another layer 702 (FIG. 7C), (iv) drilling/milling of internal feature, e.g. channels 705 (FIG. 7D) and (v) repeating the above steps as needed until the final object with internal features, e.g. channels 705 are manufactured. For instance, an object made of four solid-state printed layers 701, 702, 703 and 704 on a platform 706, where the deposited layers have connected internal channels 705, is presented in FIG. 7E.

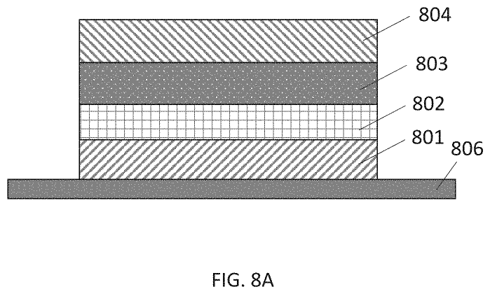

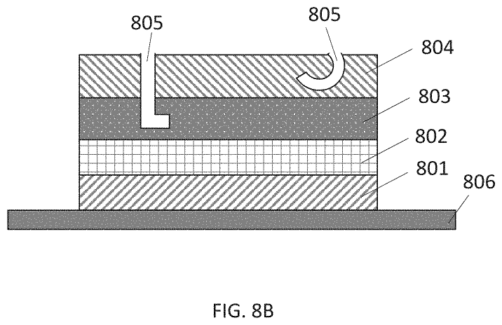

In embodiments, the solid-state additive manufacturing system performs one or more or all the additive manufacturing steps first by depositing layers, e.g. 801, 802, 803 and 804 optionally on a platform 806 (FIG. 8A), and then the subtractive manufacturing steps of material removal are performed yielding the needed surface features and/or internal features, e.g. channels 805 (FIG. 8B).

In some embodiments, the solid-state manufacturing system performs the subtractive manufacturing actions in addition to the additive manufacturing actions. The subtractive manufacturing steps remove the material (or cut the material) by processes such as milling, turning, grinding, and/or drilling. In other embodiments, the solid-state manufacturing system performs only the additive manufacturing steps, while the subtractive manufacturing steps (milling, turning, grinding, drilling) are executed by other types of machines and tools.

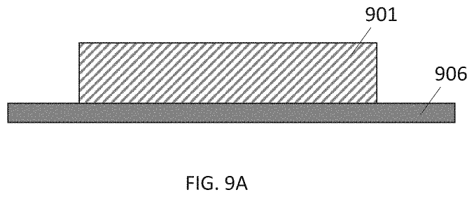

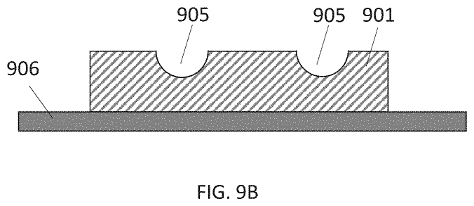

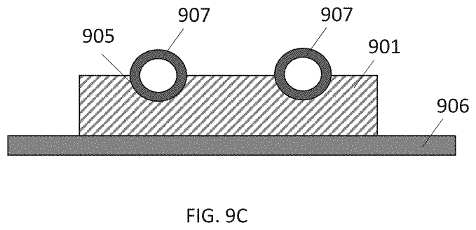

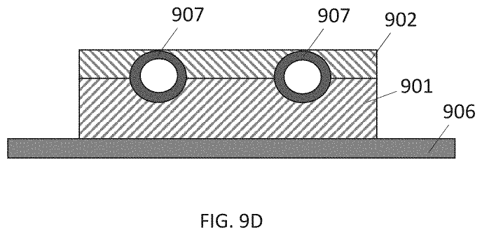

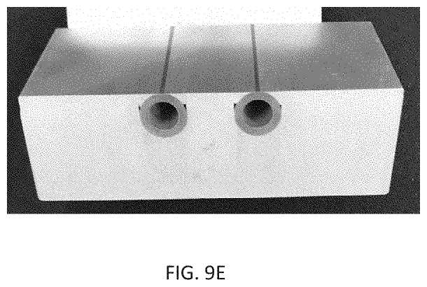

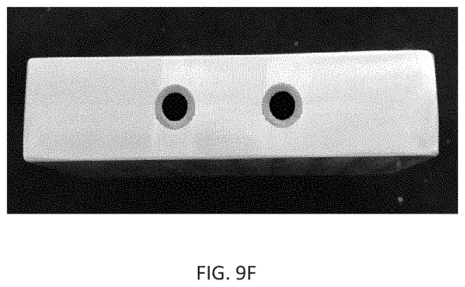

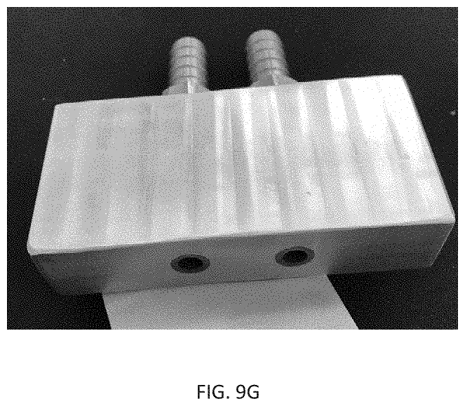

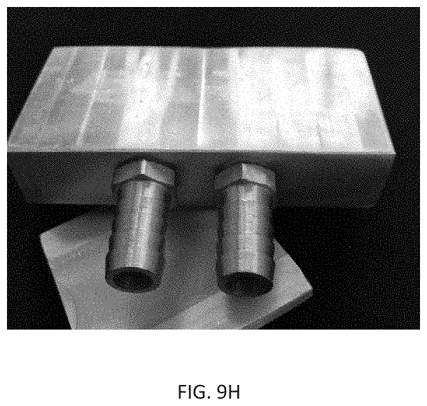

In a particular embodiment, a part requiring additive and subtractive steps is built with the solid-state manufacturing system, and other component(s), which are fabricated by a different technology, known in the art, are incorporated into the solid-state additive manufactured part. For instance, the solid-state additive fabrication starts with deposition of a layer 901 on a platform 906 (FIG. 9A). Then the layer 901 undergoes subtractive steps to take off material from certain locations in order to make channels 905, where the components manufactured by a different technology, e.g. pipes will be placed (FIG. 9B). In the next step, the components made by a different technology, e.g. pipes 907 are placed in the channels 905 in the layer 901 (FIG. 9C), and afterwards, the solid-state additive manufacturing machine starts the deposition step of the subsequent layer 902 on top of the layer 901 and embedded pipes 907 (FIG. 9D). A photograph of such a part is given in FIG. 9E, while FIG. 9F shows the same part with built extra layers on top of the initial layers 901 and 902 with the solid-state additive manufacturing machine. FIGS. 9G and 9H are photographs of the same constructed part taken from different angles.

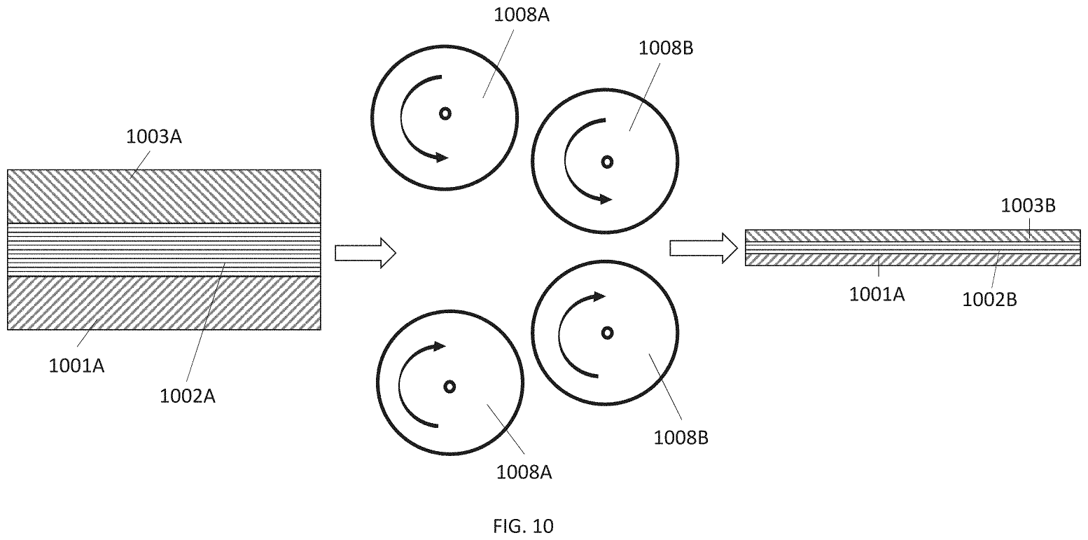

In certain embodiments, the solid-state additive manufacturing deposited layers and parts are subjected to different post-fabrication methods. For instance, in one embodiment, a stack of deposited layers 1001A, 1002A and 1003A is passed through one or more sets of hot or cold rollers, such as pairs of rollers 1008A and 1008B or through a calendaring equipment and the printed stack is compressed into a thinner stack of layers 1001B, 1002B and 1003B (FIG. 10). This is advantageous in comparison to other methods known in the art for fabrication of stacks of layers, because the solid-state additive manufacturing technology provides good bonding among the layers made of different (or dissimilar) materials in the stack, which afterwards when subjected to different post-fabrication operations, do not show signs of delamination.

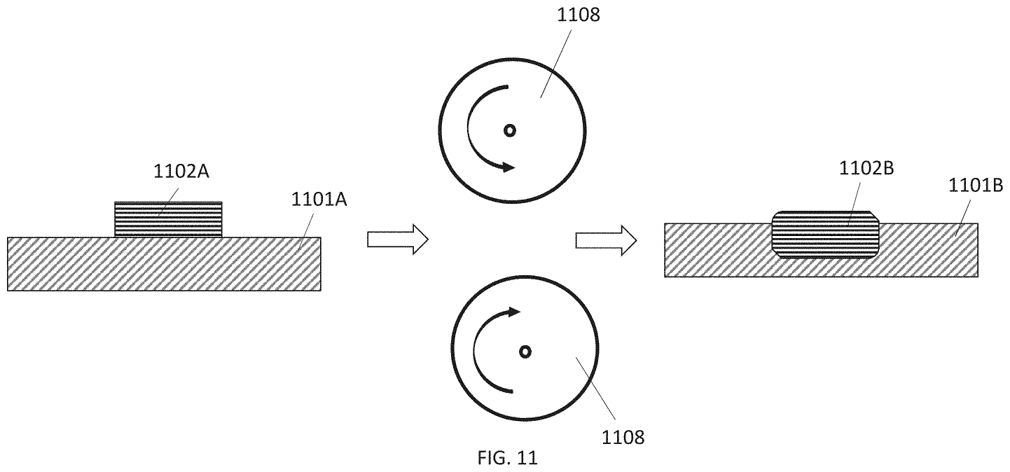

In a particular embodiment, the solid-state additive manufacturing machine deposits a first layer made of a soft material 1101A, and then deposits a feature made of a harder material 1102A, as presented in FIG. 11. Then, the built part is placed between cold or hot rollers, one or more pairs of rollers 1108, or a hydraulic press, and the feature made of the harder material 1102A becomes fully- or partially-embedded 1102B into the underlying layer 1101B made of the softer material. The shape of the embedded material 1102B can be the same or could differ than the originally-deposited material 1102A.

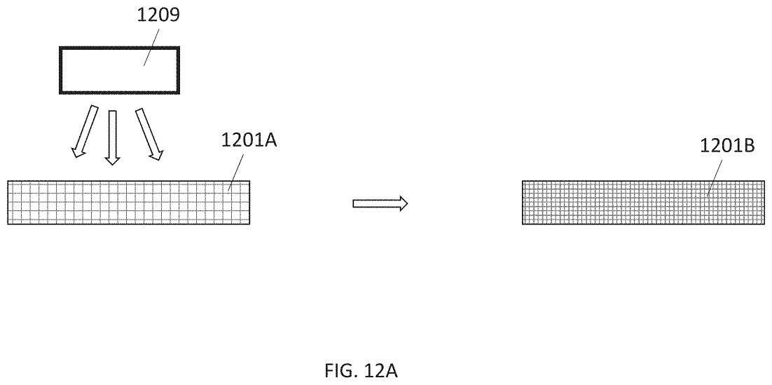

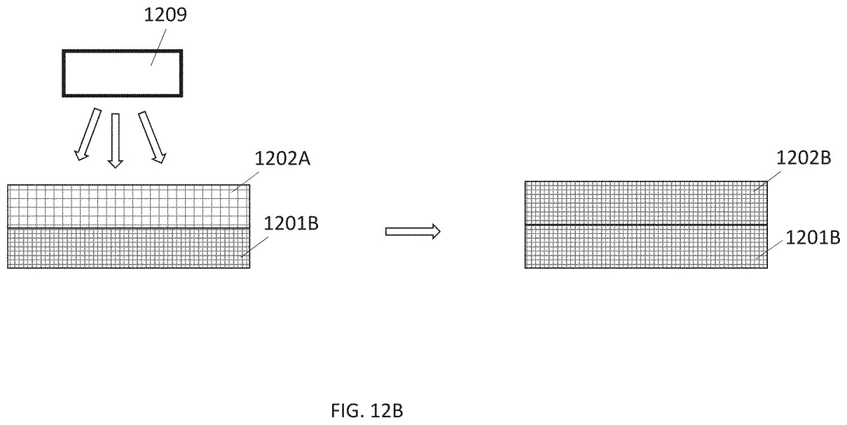

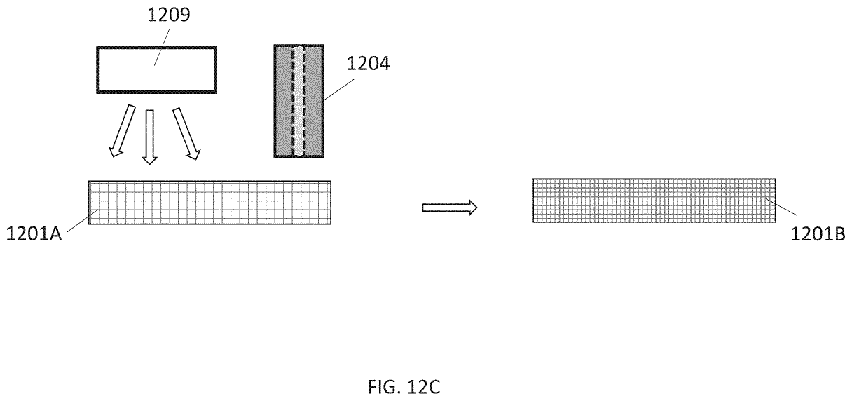

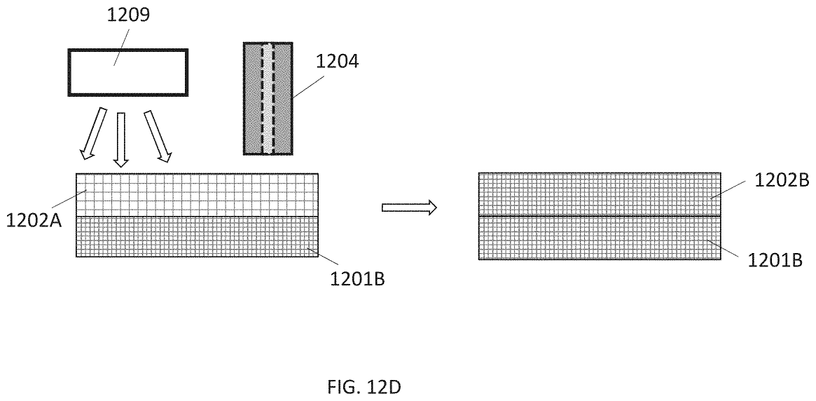

In certain embodiments, the deposits undergo a peening step performed by any of the following processes: shot peening, laser peening, ultrasound peening or their combination. For instance, in one embodiment, the layer 1201A deposited by the solid-state additive manufacturing process is subjected to peening, shot, laser or ultrasound peening or their combination 1209 (FIG. 12A). The peening process yields refinement of the original microstructure in the deposited layer 1201B. Then additional layers can be deposited by the solid-state additive manufacturing process and these layers can be subjected to the peening process 1209, which generates a refined microstructure of the original microstructure 1202A into microstructure 1202B (FIG. 12B). These steps can be repeated multiple times as needed to build the structure or the part. The microstructure 1202B is refined compared to the original solid-state additively manufactured microstructure 1202A; in some embodiments, and depending on the material, the grain sizes are in the range of 5-10 μm, or more preferably, in the range 1-5 μm or are below 1 μm, thus exhibiting ultrafine granular (UFG) microstructure.

In some embodiments, the peening process is performed along with the deposition step like the process presented schematically in FIGS. 12C and 12D. The solid-state additive manufacturing tool 1204 deposits the first layer 1201A (FIG. 12C) and the peening device 1209 subsequently affects the surface of the deposited 1201A layer and causes refinement in the microstructure yielding microstructure 1201B. Then an additional layer 1202A is deposited by the solid-state additive manufacturing tool 1204 on top of layer 1201B with refined structure and consequently the peening device 1209 causes refinement in the microstructure of the second layer 1202A yielding refined microstructure 1202B (FIG. 12D). The refined microstructure could be in the range of UFG microstructures or other range of grains much smaller than the original grains.

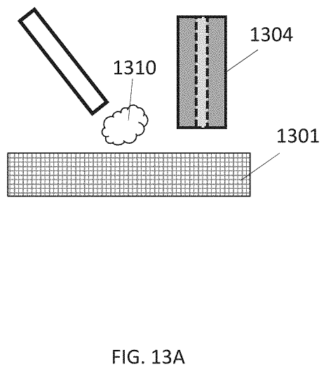

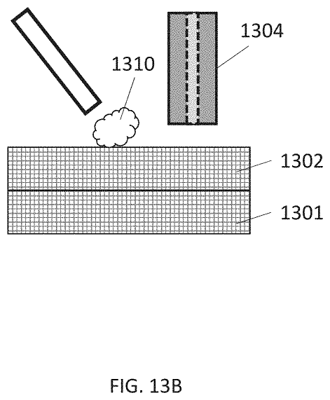

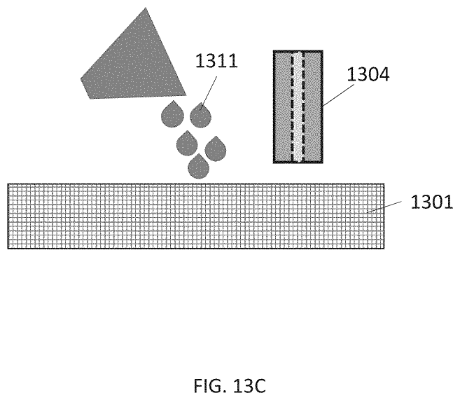

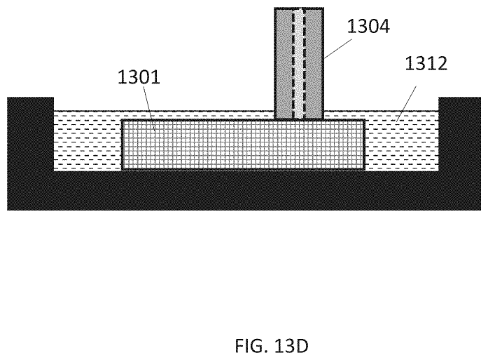

In a particular embodiment, the grain refinement is enabled by rapid cooling or quenching of the solid-state additively-manufactured deposit. As an example only, a cold air or a gas (CO₂) 1310 is blown during the deposition of a layer with a solid-state additive manufacturing tool 1304 resulting in a refined microstructure or UFG-microstructure 1301 (FIG. 13A). Multiple deposits with refined microstructures 1301, 1302, and so on are possible by repeating the step of solid-state deposition with a tool 1304 and subsequent microstructure refinement with a cold gas 1310 multiple times (FIG. 13B).

In other embodiments, a cold liquid (e.g. water) or a cold solid material (e.g. dry ice) 1311 is disposed during the deposition via the tool 1304 for quick cooling of the deposited layer, and thus, causes refinement of the deposited microstructures 1301 (FIG. 13C).

In yet another embodiment, the deposition via the tool 1304 occurs in a circulating cold medium 1312, and thus, the microstructure refinement occurs simultaneously during the deposition (FIG. 13D).

In particular embodiments, a plasma or a laser action is used to generate changes in the microstructures of the deposited layer.

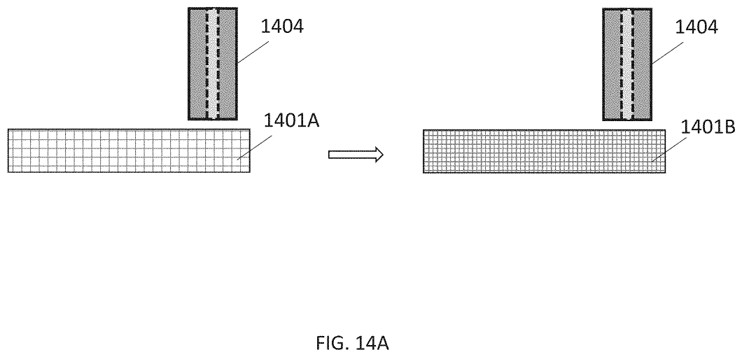

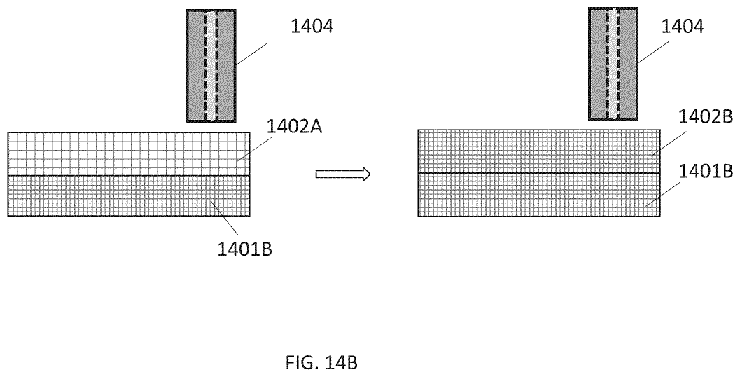

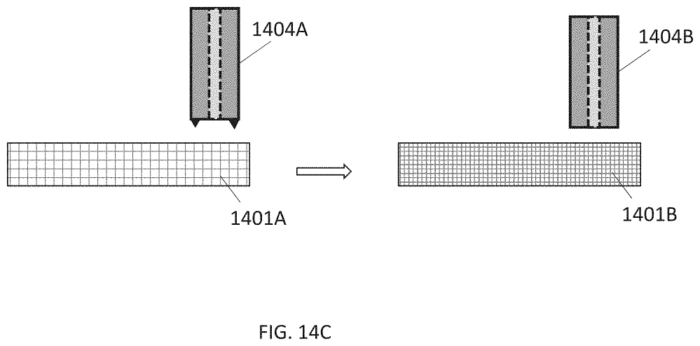

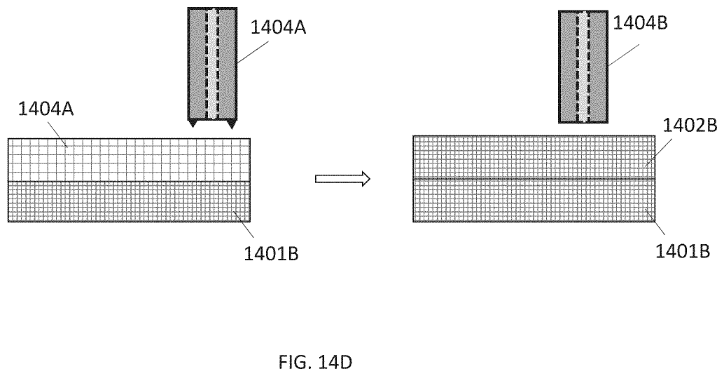

In certain embodiments, the tool 1404 is used to deposit layer 1401A and the tool is used again to move along the surface of the deposited layer to generate refined microstructures or even UFG-microstructures 1401B (FIG. 14A). In particular, the same tool is used to deposit the original layer 1401A and with repeated movements is used only as a compression and/or friction tool without adding the filler material, while in other embodiments, the rate of deposition of the filler material in the original step is different than the rate of adding the material in the repeated steps. The processing conditions, e.g. tool rotation, tool transverse speed, tool temperature, and so on, vary between the original deposition step and the repeated movements. These action steps repeat multiple times, as needed, to build a structure or a part made of layers with refined microstructures 1401B, 1402B, and so on (FIG. 14B).

In other embodiments, the tool geometry and/or the tool shoulder features vary between the original deposition step and the repeated steps (FIG. 14C). For instance, a tool with specific geometry/tool shoulder features 1404A is used in the original solid-state deposition of the layer 1401A. Then the tool is switched to a tool with no geometry/no tool features 1404B and moves along the surface of the deposited layer 1401A causing microstructure refinement or UFG-microstructures 1404B. These steps of switching between tools 1404A and 1404B can be repeated multiple times, as needed, in building parts or structures made of multiple layers with refined microstructures 1401B, 1402B, and so on (FIG. 14D).

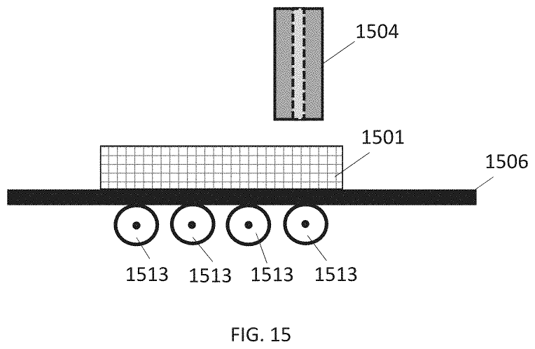

In certain embodiment, one or more rollers 1513 are used under the platform 1506, where the solid-state additive manufacturing occurs via a tool 1504 (FIG. 15). The microstructure of the deposited layer 1501 is affected by the movement of the rollers 1513 underneath. The rollers 1513 control the stress applied on the deposited layer during the deposition and afterwards by the tool 1504 and the platform 1506.

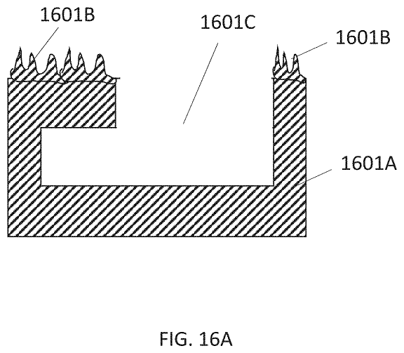

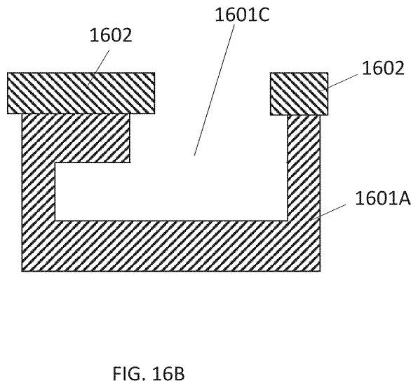

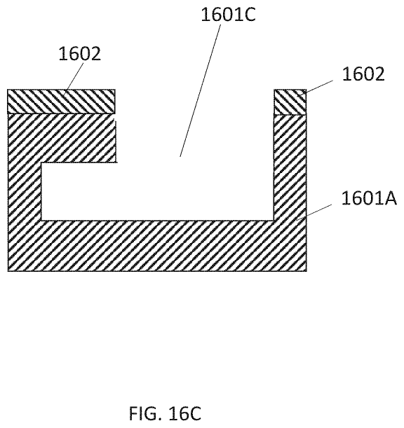

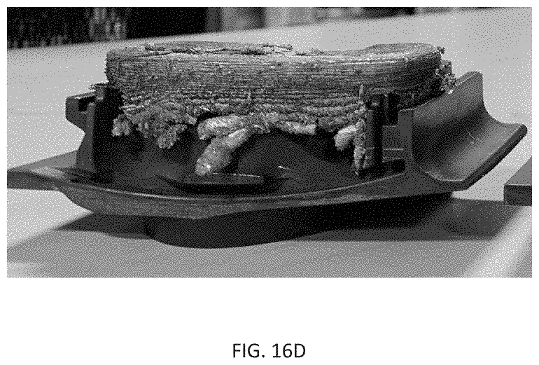

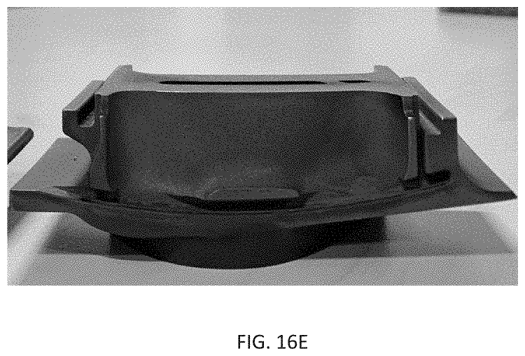

In some aspects, the solid-state manufacturing hybrid machine is used for repair of hard to repair parts or parts made of non-weldable materials. The repair process might involve additive steps only or subtractive steps only, or both—a combination of additive and subtractive steps. For example, in one embodiment the surface of a part 1601A is heavily corroded 1601B (FIG. 16A). The part includes a cavity with a surface opening 1601C that makes the repair process of the corroded surface with conventional methods, known in the art, more difficult. The corroded part 1601A without any prior surface preparation is subjected to the solid-state additive repair process and an additional layer 1602 is added on top of the corroded surface of the part 1601A (FIG. 16B). Then, in the next step of machining, the extra material is taken and the corroded surface is covered with layer 1602, which can be the same or different material as the material that the part 1601A is made of (FIG. 16C). A particular example of a solid-state additive manufacturing repair process is given in FIGS. 16D and 16E. A blade with an internal hole is repaired (FIG. 16D) with the solid-state additive manufacturing process without prior surface preparation, and then, the repaired blade is machined down (FIG. 16E).

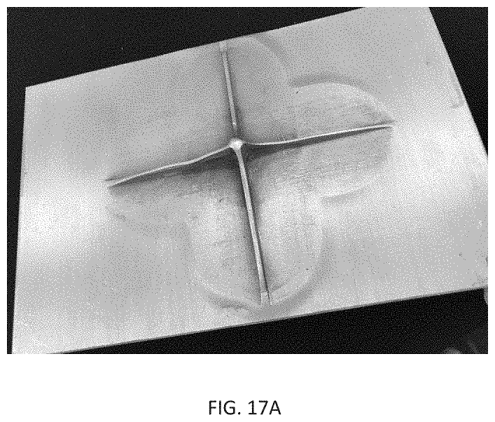

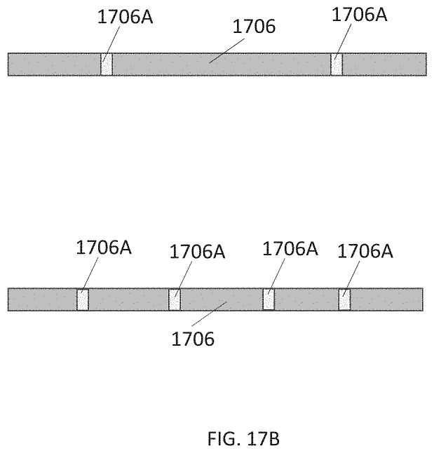

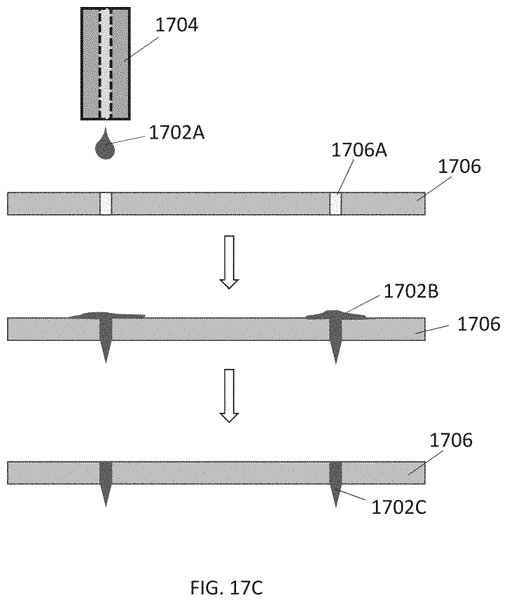

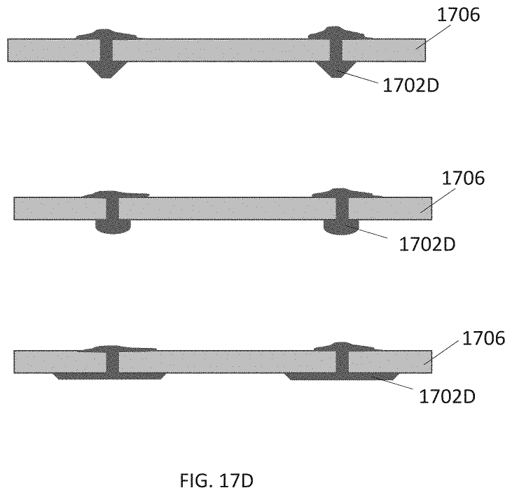

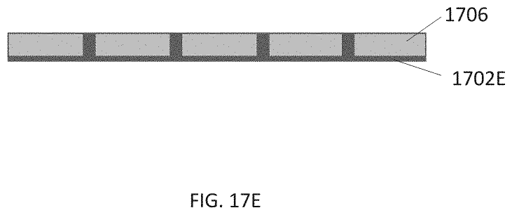

In some aspects, the hybrid solid-state additive manufacturing system is used for extrusion of features, which are difficult to be added or manufactured by other processes known in the art, such as by bonding prefabricated parts to the structure which introduces a bond (adhesive) as a weak point in the structure. In a particular embodiment, strengthening ribs or stiffening ribs are extruded by the solid-state additive manufacturing; a photograph of a plate with stiffening ribs that have been extruded with the solid-state additive process is presented in FIG. 17A. For this purpose, in one embodiment, the plate used as a substrate 1706 for the solid-state additive printing has slots (dies) 1706A (FIG. 17B). The solid-state additive manufacturing tool 1704 deposits the material on the back of the substrate 1706 and the material 1702A is pushed through the slot (die) on the back side of the plate forming ribs 1702C, enhancement and/or locking structures 1702D (FIGS. 17C and 17D). In a particular embodiment and depending on the flowing characteristics of the material 1702A and the processing conditions applied, the material 1702A pushed throughout the slots of the substrate 1706A serves as a coating 1702E on the back side of the substrate 1706A (FIG. 17E). The front side can be polished or machined to remove extra deposited material.

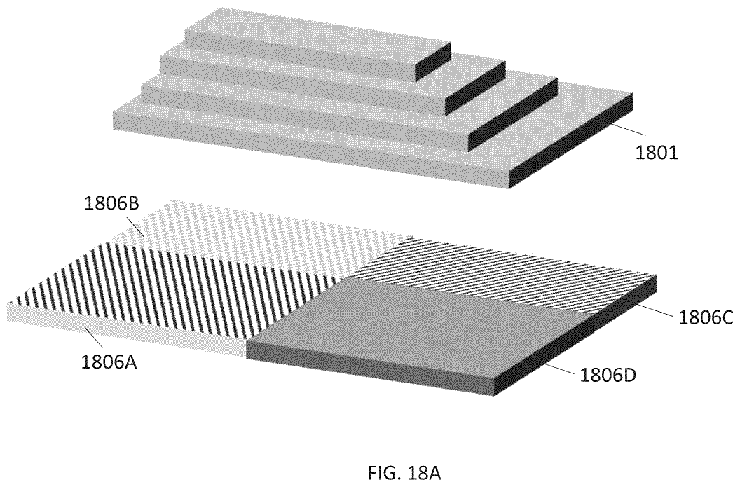

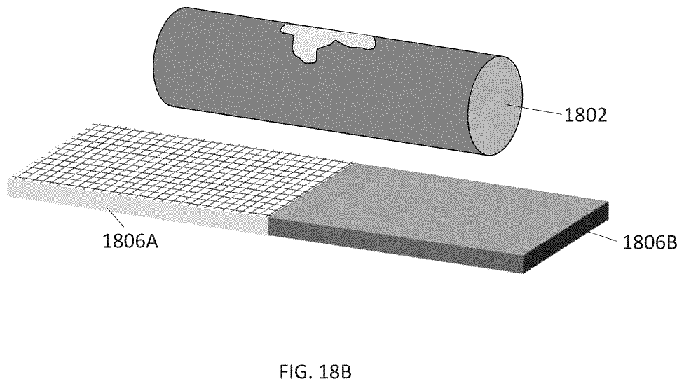

In some aspects, large objects are built by the solid-state additive manufacturing process and a modular platform to support such large object is used. A particular example involves a modular platform including 4 constituent parts: 1806A, 1806B, 1806C and 1806D (FIG. 18A). Such platform efficiently supports the stresses during the building of a large and/or heavy part 1801 by the hybrid solid-state additive and subtractive manufacturing steps. In another embodiment, the modular platform includes an elongated, large aspect ratio platform including plates 1806A and 1806B, to support an elongated object, such as pipe 1802 that is subjected to repair by the hybrid solid-state manufacturing processes (FIG. 18B).

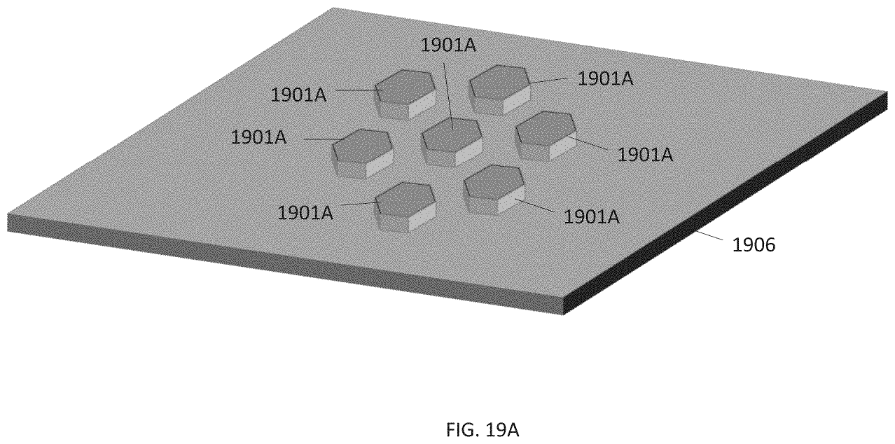

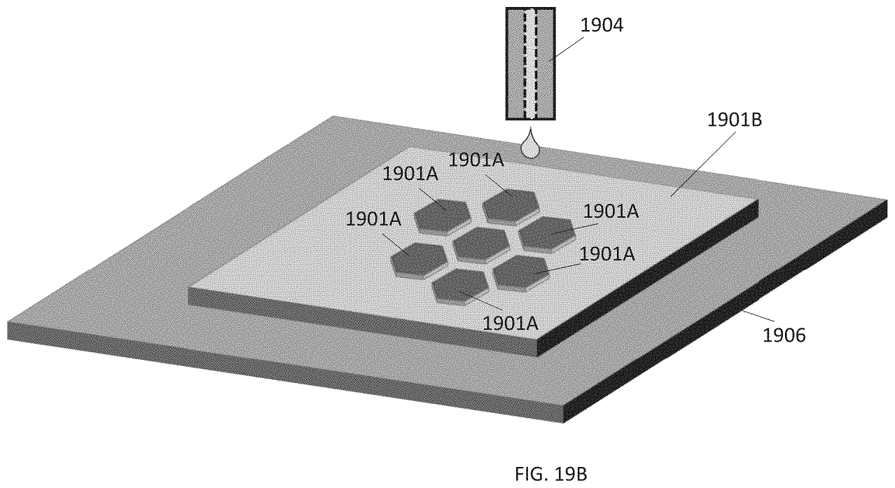

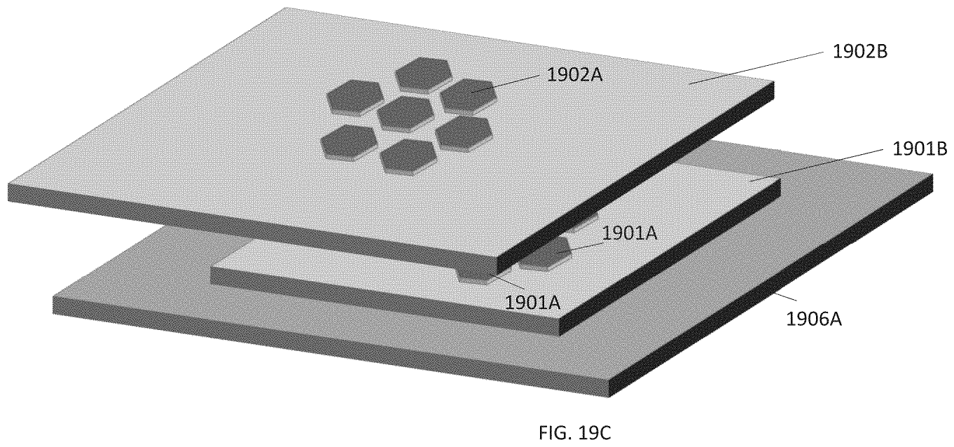

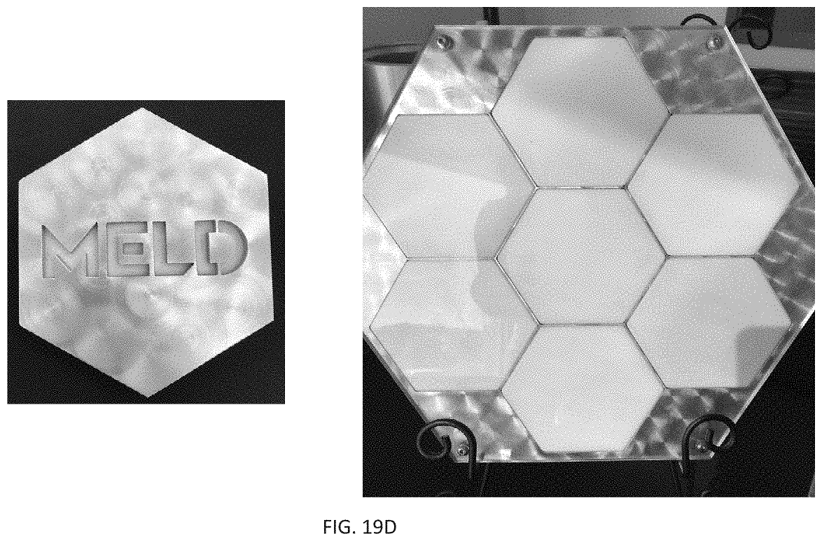

In some aspects, parts of the final objects are fabricated prior to the hybrid solid-state manufacturing processes. Such parts are used as templates or as building blocks to achieve the final desired structure. For instance, in one embodiment, hexagonal parts made of ceramics or high-performance plastics 1901A are placed on a platform/substrate 1906 (FIG. 19A), and then a material 1901B is deposited via a solid-state additive manufacturing tool 1904 around these parts 1901A (FIG. 19B). In some embodiments, the steps can be repeated multiple times to achieve a multilayered composite structure including the initial substrate/platform 1906A, deposited layer 1901B containing the parts 1901A, then another substrate 1906B with the parts 1902A embedded in the deposited layer 1902B, and so on (FIG. 19C). Such structures with embedded ceramic hexagonal parts could be used in ballistic and other military applications. Photographs of ceramic hexagonal parts embedded in aluminum layers deposited by solid-state additive manufacturing and machined afterwards are given in FIG. 19D.

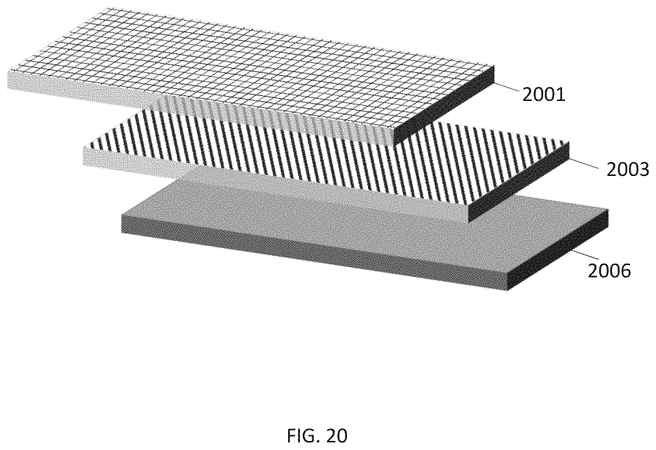

In some aspects, a composite or prepreg layer is added during the hybrid additive and subtractive solid-state manufacturing steps. In one embodiment, the composite layer 2003 including for example carbon fibers uniaxially or biaxially laid in a polymer matrix is placed on top of the substrate 2006, and then the next layer 2001 is deposited on top of the composite layer 2003 by solid-state additive manufacturing (FIG. 20). In another embodiment, the layer 2003 is a prepreg layer, e.g. a sheet of uniaxial, biaxial or multiaxially-laid carbon fibers or other fibers. In some embodiments, the composite or prepreg layer 2003 is previously treated by chemical means, laser or plasma or any other means to induce surface activation or functionalization and promote better bonding to the layer underneath (the substrate) and the layer on top. These steps can be repeated to build multi-layer structures including multiple composite and/or prepreg layers and solid-state deposited layers in-between.

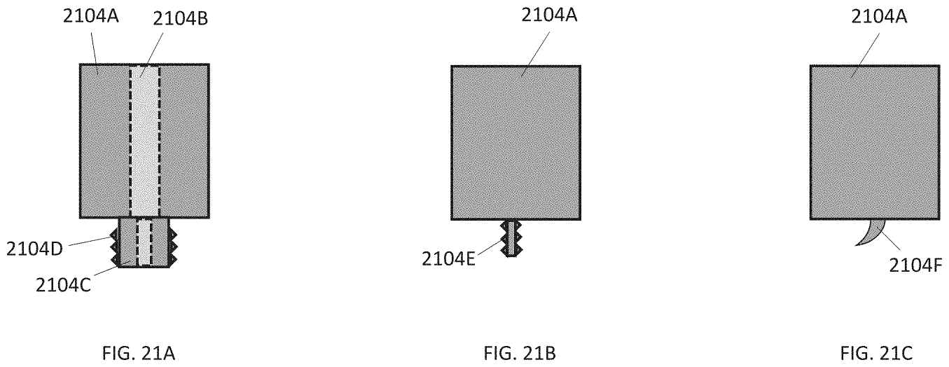

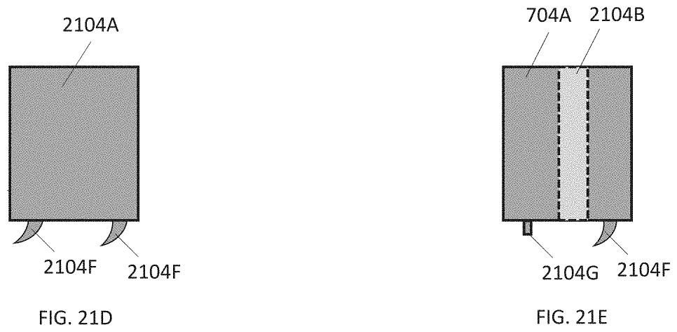

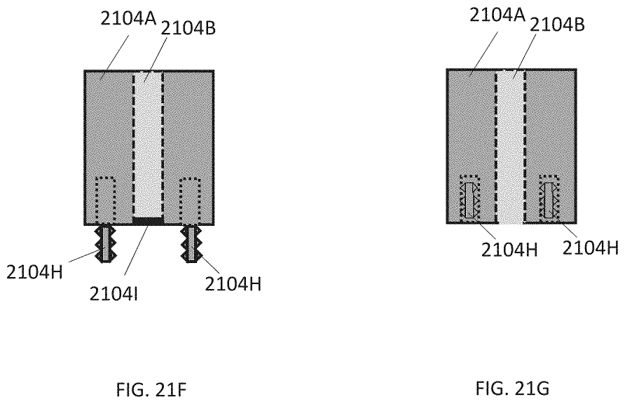

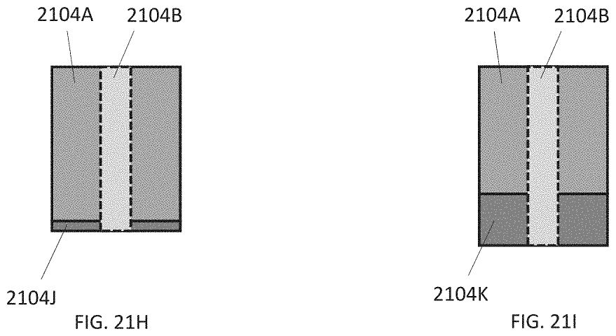

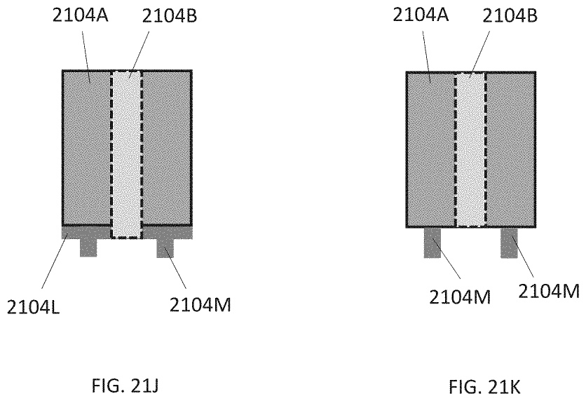

In some aspects, the deposition of a filler material and introduction of grooves, holes or channels in a part or on a surface of a substrate are all performed with hybrid solid-state deposition/grooving tools having a variety of shapes, extensions and/or surface features. In one embodiment, the tool has a body 2104A with a passage (channel) 2104B for the supply of the filler material, an extension—hollow pin 2104C to supply the filler material and drilling features 2104D (FIG. 21A). Tools without channels but only different drilling features 2104E or cutting features 2104F are presented in FIGS. 21B and 21C, respectively. One or more drilling or cutting tool extensions, similar or different in shape and size, 2104F and 2104G, might extend from the tool shoulder (FIGS. 21D and 21E). By application of high intensity friction and other forces between the tool shoulder and its extensions on the surface of the part or substrate, drilling occurs. After the formation of holes or channels, the next manufacturing step is performed by switching the drilling tool with a solid-state additive manufacturing tool with an internal passageway through which a filler material is added.

In other embodiments, a hybrid solid-state manufacturing tool capable of performing both the additive and the subtractive manufacturing steps is used. As an example, the tool extensions on the solid-state manufacturing tool are retractable 2104H (FIGS. 21F and 21G). More specifically, the filler material passageway closes with a “door” 21041, when the extensions are extended from the tool shoulder (FIG. 21F). Once the extensions are retracted within the body of the tool, the passageway opens up and the filler is enabled to pass through on the working surface (FIG. 21G).

In some embodiments, the tool surface is coated with ceramic coating 2104J to increase the wear (abrasion) resistance during tool deposition and drilling (FIG. 21H), while in other embodiments, a part of the tool 2104K is fabricated with ceramic material to increase the tool wear resistance, and thus, the lifetime (FIG. 21I). Any other material known in the art to have high wear/abrasion resistance might be use for making the tool coating 2104J or the tool portion 2104K. In yet another embodiment, the tool part with increased wear resistance can have nubs or other surface features to enable better mixing, drilling or other operation (FIGS. 21J and 21K).

According to embodiments, the solid-state additive manufacturing process(es) are executed by a machine or system (e.g. solid-state additive manufacturing machine or solid-state additive manufacturing system, used interchangeably herein) which may be or include any tool (solid-state additive manufacturing tool) described in, for example US Application Publication Nos. 2010/0285207, 2012/0279441, 2015/0165546, 2017/0216962, which are hereby incorporated by reference herein in their entireties. According to one embodiment, the solid-state additive manufacturing machine or solid-state additive manufacturing system includes a friction-based fabrication tool including: a non-consumable body formed from material capable of resisting deformation when subject to frictional heating and compressive loading and a throat defining a passageway lengthwise through the body and shaped for exerting normal forces on a material in the throat during rotation of the body.

According to another embodiment, the solid-state additive manufacturing machine includes a non-consumable member having a body and a throat; wherein the throat is shaped to exert a normal force on a consumable material disposed therein for imparting rotation to the coating material from the body when rotated at a speed sufficient for imposing frictional heating of the coating material against a substrate; wherein the body is operably connected with a downward force actuator for dispensing and compressive loading of the consumable material from the throat onto the substrate and with one or more actuators or motors for rotating and translating the body relative to the substrate; wherein the body includes a surface for trapping the consumable material loaded on the substrate in a volume between the body and the substrate and for forming and shearing a surface of a coating on the substrate.

Other specific embodiments include friction-based fabrication tools including: (a) a spindle member including a hollow interior for housing a consumable coating or filler material disposed therein prior to deposition on a substrate; wherein the interior of the spindle is shaped to exert a normal force on the consumable material disposed therein for rotating the consumable material during rotation of the spindle; (b) a downward force actuator, in operable communication with the spindle, for dispensing and compressive loading of the consumable material from the spindle onto the substrate and with one or more motors or actuators for rotating and translating the spindle relative to the substrate; and wherein the spindle includes a shoulder surface with a flat surface geometry or a surface geometry with structure for enhancing mechanical stirring of the loaded consumable material, which shoulder surface is operably configured for trapping the loaded consumable material in a volume between the shoulder and the substrate and for forming and shearing a surface of a coating on the substrate.

In some embodiments, the throat has a non-circular cross-sectional shape.

Additionally, any filler material can be used as the consumable material, including consumable solid, powder, or powder-filled tube type coating materials. In the case of powder-type coating material, the powder can be loosely or tightly packed within the interior throat of the tool, with normal forces being more efficiently exerted on tightly packed powder filler material. Packing of the powder filler material can be achieved before or during the coating process.

Further provided are tooling configurations including any configuration described in this specification, or any configuration needed to implement a method according to the invention described herein, combined with a consumable filler material member. Thus, tooling embodiments of the invention include a non-consumable portion (resists deformation under heat and pressure) alone or together with a consumable coating material or consumable filler material (e.g., such consumable materials include those that would deform, melt, or plasticize under the amount of heat and pressure the non-consumable portion is exposed to).

Another aspect of the present invention is to provide a method of forming a surface layer on a substrate, such as repairing a marred surface, building up a surface to obtain a substrate with a different thickness, joining two or more substrates together, or filling holes in the surface of a substrate. Such methods can include depositing a coating or filler material on the substrate with tooling described in this application, and optionally friction stirring the deposited coating material, e.g., including mechanical means for combining the deposited coating material with material of the substrate to form a more homogenous coating-substrate interface. Depositing and stirring can be performed simultaneously, or in sequence with or without a period of time in between. Depositing and stirring can also be performed with a single tool or separate tools, which are the same or different.

Particular methods include depositing a coating on a substrate using frictional heating and compressive loading of a coating material against the substrate, whereby a tool supports the coating material during frictional heating and compressive loading and is operably configured for forming and shearing a surface of the coating.

In embodiments, the tool and consumable material preferably rotate relative to the substrate. The tool can be attached to the consumable material and optionally in a manner to allow for repositioning of the tool on the coating material. Such embodiments can be configured to have no difference in rotational velocity between the coating material and tool during use. The consumable material and tool can alternatively not be attached to allow for continuous or semi-continuous feeding or deposition of the consumable material through the throat of the tool. In such designs, it is possible that during use there is a difference in rotational velocity between the consumable material and tool during the depositing. Similarly, embodiments provide for the consumable material to be rotated independently or dependently of the tool.

Preferably, the consumable material is delivered through a throat of the tool and optionally by pulling or pushing the consumable material through the throat. In embodiments, the consumable material has an outer surface and the tool has an inner surface, wherein the outer and inner surfaces are complementary to allow for a key and lock type fit. Optionally, the throat of the tool and the consumable material are capable of lengthwise slidable engagement. Even further, the throat of the tool can have an inner diameter and the consumable material can be a cylindrical rod concentric to the inner diameter. Further yet, the tool can have a throat with an inner surface and the consumable material can have an outer surface wherein the surfaces are capable of engaging or interlocking to provide rotational velocity to the consumable material from the tool. In preferred embodiments, the consumable filler or coating material is continuously or semi-continuously fed and/or delivered into and/or through the throat of the tool. Shearing of any deposited consumable material to form a new surface of the substrate preferably is performed in a manner to disperse any oxide barrier coating on the substrate.

Yet another aspect of the present invention is to provide a method of forming a surface layer on a substrate, which includes filling a hole in a substrate. The method includes placing powder of a fill material in the hole(s) and applying frictional heating and compressive loading to the fill material powder in the hole to consolidate the fill material.

In yet another embodiment, the solid-state additive manufacturing machine, in addition to including a tool described in this specification, includes a substrate. Materials that can serve as the consumable filler material or as the substrate(s) can include metals and metallic materials, polymers and polymeric materials, ceramic and other reinforced materials, as well as combinations of these materials. In embodiments, the filler material can be of a similar or dissimilar material as that of the substrate material(s). The filler material and the substrate(s) can include polymeric material or metallic material, and without limitation include metal-metal combinations, metal matrix composites, polymers, polymer matrix composites, polymer-polymer combinations, metal-polymer combinations, metal-ceramic combinations, and polymer-ceramic combinations.

In one particular embodiment, the filler material includes conductive material such as any form of metal or metallic filler material described herein. The conductive filler material, or the substrate(s) can be independently selected from any metal, including for example Al, Ni, Cr, Cu, Co, Au, Ag, Mg, Cd, Pb, Pt, Ti, Zn, or Fe, Nb, Ta, Mo, W, metal oxides, or an alloy including one or more of these metals. In embodiments, the filler material or the substrate(s) include non-conductive material such as polymeric material or plastic material. Non-limiting examples of polymeric materials useful as a filler material include polyolefins, polyesters, nylons, vinyls, polyvinyls, acrylics, polyacrylics, polycarbonates, polystyrenes, polyurethanes, and the like. Additional examples are provided below.

In still yet another embodiment, the filler material is a composite material including at least one metallic material and at least one polymeric material. In other embodiments, multiple material combinations can be used for producing a composite at the interface.

The filler materials can be in several forms, including but not limited to: 1) metal powder or rod of a single composition; 2) matrix metal and reinforcement powders can be mixed and used as feed material; or 3) a solid rod of matrix can be bored (e.g., to create a tube or other hollow cylinder type structure) and filled with reinforcement powder, or mixtures of metal matric composite and reinforcement material. In the latter, mixing of the matrix and reinforcement can occur further during the fabrication process. In embodiments, the filler material may be a solid metal rod. In one embodiment, the filler material is aluminum.

According to embodiments, the filler material and/or the substrate(s) are independently chosen from plastics, homo polymers, co-polymers, or polymeric materials including polyesters, nylons, polyvinyls such as polyvinyl chloride (PVC), polyvinylidene chloride (PVDC), polyvinylidene fluoride (PVDF), polyacrylics, polyethylene terephthalate (PET or PETE), Polybutylene terephthalate (PBT), polyamides (PA), Nylons (Ny6, Ny66), polylactide, polycarbonates, polystyrenes, polyurethanes, engineering polymers such as Polyetherketone (PEK), Polyetheretherketone (PEEK), polyaryletherketone (PAEK), Acrylonitrile butadiene styrene (ABS), Polyphenylene sulfide (PPS), Polysulphone (PSU), polyphenylsulfone (PPSU), Polyphenylene oxide (PPO), Polyphenylene sulfide (PPS), Polyoxymethylene plastic (POM), polyphthalamide (PPA), polyarylamide (PARA), and/or polyolefins such as high density polyethylene (HDPE), low density polyethylene (LDPE), cyclic olefin copolymers (COC), polypropylene, composites, mixtures, reinforcement materials, or a metal matrix composite including a metal matrix and a ceramic phase, wherein the metal matrix includes one or more of a metal, a metal alloy, or an intermetallic, and the ceramic phase includes a ceramic, and independently chosen from metallic materials, metal matrix composites (MMCs), ceramics, ceramic materials such as SiC, TiB2 and/or Al2O3, metals including steel, Al, Ni, Cr, Cu, Co, Au, Ag, Mg, Cd, Pb, Pt, Ti, Zn, Fe, Nb, Ta, Mo, W, metal oxides, or an alloy including one or more of these metals, as well as combinations of any of these materials.

The present invention has been described with reference to particular embodiments having various features. In light of the disclosure provided above, it will be apparent to those skilled in the art that various modifications and variations can be made in the practice of the present invention without departing from the scope or spirit of the invention. One skilled in the art will recognize that the disclosed features may be used singularly, in any combination, or omitted based on the requirements and specifications of a given application or design. When an embodiment refers to “comprising” certain features, it is to be understood that the embodiments can alternatively “consist of” or “consist essentially of” any one or more of the features. Other embodiments of the invention will be apparent to those skilled in the art from consideration of the specification and practice of the invention.

It is noted in particular that where a range of values is provided in this specification, each value between the upper and lower limits of that range is also specifically disclosed. The upper and lower limits of these smaller ranges may independently be included or excluded in the range as well. The singular forms “a,” “an,” and “the” include plural referents unless the context clearly dictates otherwise. It is intended that the specification and examples be considered as exemplary in nature and that variations that do not depart from the essence of the invention fall within the scope of the invention. Further, all of the references cited in this disclosure are each individually incorporated by reference herein in their entireties and as such are intended to provide an efficient way of supplementing the enabling disclosure of this invention as well as provide background detailing the level of ordinary skill in the art.

1. A hybrid manufacturing process comprising:
depositing filler material(s) by a hybrid manufacturing system by way of one or more additive steps to form a 3D printed part, optionally wherein the additive steps comprise:
feeding one or more filler material(s) through a hollow spindle or tool of the hybrid manufacturing system;
depositing the filler materials(s) onto a substrate; and
generating plastic deformation of the filler material(s) and the substrate by applying normal, shear and/or frictional forces by way of a rotating shoulder of the hollow spindle or tool such that the filler material(s) and/or the substrate are in a malleable and/or visco-elastic state in an interface region, thereby producing the 3D printed part; and
removing material from the 3D printed part by the hybrid manufacturing system by way of one or more subtractive steps such that surface and/or internal features are formed on and/or within the 3D printed part to form a finished part.

2. The process of claim 1, wherein the hybrid manufacturing process does not require additional tools, machines and/or equipment to complete the finished part.

3. The process of claim 1, wherein the hybrid manufacturing process requires additional tools, machines and/or equipment to complete the finished part.

4. The process of claim 1, further comprising fabricating the 3D printed part by way of one or more post-fabrication steps, which steps are performed by other tools and/or machines.

5. The process of claim 4, wherein the one or more post-fabrication steps comprise calendaring steps.

6. The process of claim 4, wherein the one or more post-fabrication steps comprise compressing steps performed by and/or between one or more pairs of cold rollers.

7. The process of claim 4, wherein the one or more post-fabrication steps comprise compressing steps performed by and/or between one or more pairs of hot rollers.

8. The process of claim 4, wherein the one or more post-fabrication steps comprise cooling the 3D printed part.

9. The process of claim 4, wherein the one or more post-fabrication steps comprise quenching the 3D printed part.

10. The process of claim 4, wherein the one or more post-fabrication steps comprise heating the 3D printed part.

11. The process of claim 4, wherein the one or more post-fabrication steps comprise peening the 3D printed part.

12. The process of claim 4, wherein the one or more post-fabrication steps comprise lasering the 3D printed part.

13. The process of claim 1, further comprising one or more additional processing steps.

14. The process of claim 13, wherein the one or more additional processing steps comprise peening.

15. The process of claim 13, wherein the one or more additional processing steps comprise lasering.

16. The process of claim 13, wherein the one or more additional processing steps comprise cooling.

17. The process of claim 13, wherein the one or more additional processing steps comprise quenching.

18. The process of claim 1, wherein the hybrid manufacturing process is capable of producing internal features in the finished part.

19. The process of claim 1, wherein the hybrid manufacturing process is capable of producing surface features in the finished part.

20. The process of claim 1, wherein the hybrid manufacturing process is capable of producing heating or cooling channels in the finished part.

21-80. (canceled)
